(19) United States
(12) Patent Application Publication
(10) Pub. No.: US 2020/0359055 A1
(43) Pub. Date: Nov. 12, 2020

(54) DECODING DEVICE AND CONTROL METHOD OF DECODING DEVICE

(71) Applicant: RENESAS ELECTRONICS CORPORATION, Tokyo (JP)

(72) Inventor: Katsumasa MATSUNAGA, Tokyo (JP)

(21) Appl. No.: 16/834,801

(22) Filed: Mar. 30, 2020

(30) Foreign Application Priority Data
May 8, 2019 (JP) 2019-088625

(51) Int. Cl. H04N 19/625; H04N 19/64; H04N 19/91; H04N 19/44

(52) U.S. Cl. CPC H04N 19/625; H04N 19/45; H04N 19/91; H04N 19/647

(57) ABSTRACT

A decoding device includes a decoding processing unit which outputs a transform coefficient matrix with m×n elements, EOB information and ZRL information, and a two-dimensional IDCT processing unit. The two-dimensional IDCT processing unit includes an IDCT determination unit which determines the number of elements in a row direction and a column direction required to select the m×n element IDCT processing or the p×q element IDCT processing based on the transform coefficient matrix with the m×n elements, the EOB information, and the ZRL information, an m×n IDCT processing unit which performs the m×n element IDCT processing, and a p×q IDCT processing unit which performs the p×q element IDCT processing. The m×n IDCT processing unit and the p×q IDCT processing unit selectively performs the m×n element IDCT processing or the p×q element IDCT processing based on a determination result by the IDCT determination unit.

### CROSS-REFERENCE TO RELATED APPLICATIONS

The disclosure of Japanese Patent Application No. 2019-088625 filed on May 8, 2019 including the specification, drawings and abstract is incorporated herein by reference in its entirety.

### BACKGROUND

The present disclosure relates to a decoding device and a control method of the decoding device.

Since an amount of information of image data is large, transmission and recording are performed after the amount of the information is reduced by compression-encoding. As a method for preforming compression-encoding on image data, for example, a Moving Picture Experts Group (MPEG) method, which is a compression-encoding method for moving images, or a Joint Photographic Experts Group (JPEG) method, which is a compression-encoding method for still images, is known.

In the MPEG method and JPEG method, when compress-encoding is performed on image data, discrete cosine transform processing is performed. Further, when image data on which compression-encoding is performed is decoded to original image data, inverse discrete cosine transform processing is performed. Hereinafter, the discrete cosine transform is referred to as DCT, and the inverse discrete cosine transform is referred to as IDCT.

There are disclosed techniques listed below.

[Patent Document 1] Japanese Unexamined Patent Application Publication No. Hei 3-166824

Patent Document 1 discloses a decoding method in which IDCT processing is performed using an inverse orthogonal matrix in which column vectors are rearranged in the order of transform coefficients to be transmitted. In the decoding method of Patent Document 1, the processing of rearranging the transform coefficients becomes unnecessary, and wasteful operation times can be reduced by performing the truncation control of the matrix operation in the IDCT depending on the number of transform coefficients.

### SUMMARY

However, although Patent Document 1 can reduce the processing amount for rearranging the transform coefficients and the processing amount for IDCT, it is required to create an inverse orthogonal matrix in which the column vectors are rearranged in the order of the transmitted transform coefficients. When the amount of processing required to create the inverse orthogonal matrix exceeds the effects of reducing the processing amount for rearranging the transform coefficients and the processing amount for IDCT, the speed-up of IDCT processing cannot be expected.

Other objects and novel features will be apparent from the description of this specification and the accompanying drawings.

A decoding device according to one embodiment includes a decoding processing unit which outputs a transform coefficient matrix with m×n elements obtained by rearranging a decoded transform coefficient sequence in a form of a zigzag scan matrix, EOB information and ZRL information, and a two-dimensional IDCT processing unit which performs m×n element IDCT processing or p×q element IDCT processing on the transform coefficient matrix with the m×n elements. The two-dimensional IDCT processing unit includes an IDCT determination unit which determines the number of elements in a row direction and a column direction required to select the m×n element IDCT processing or the p×q element IDCT processing based on the transform coefficient matrix with the m×n elements, the EOB information, and the ZRL information, an m×n IDCT processing unit which performs the m×n element IDCT processing, and a p×q IDCT processing unit which performs the p×q element IDCT processing. The m×n IDCT processing unit and the p×q IDCT processing unit selectively performs the m×n element IDCT processing or the p×q element IDCT processing based on a determination result by the IDCT determination unit, and decodes image data for each block of m×n pixels.

In the decoding device according to one embodiment, the processing amount for determination processing of the coefficient which is 0 can be reduced, thereby speeding up the decoding processing.

### BRIEF DESCRIPTION OF THE DRAWINGS

FIG. 1 is a diagram for explaining a scan order of a zigzag scan matrix.

FIG. 2 is a diagram showing an example of coefficient distribution of a transform coefficient matrix.

FIG. 3 is a diagram showing an example of the coefficient distribution of the transform coefficient matrix.

FIG. 4 is a diagram for explaining zero-coefficient determination processing.

FIG. 5 is a block diagram showing an example of a configuration of a decoding device according to one embodiment.

FIG. 6 is a block diagram showing an example of a configuration of a decoding processing unit according to one embodiment.

FIG. 7 is a block diagram showing an example of a configuration of an IDCT determination unit according to one embodiment.

FIG. 8 is a flowchart showing an example of a processing flow of an EOB determination unit according to one embodiment.

FIG. 9 is a flowchart showing an example of a processing flow of a zero-coefficient determination unit according to one embodiment.

FIG. 10 is a diagram for explaining a plurality of examples of the zero-coefficient determination processing.

FIG. 11 is a block diagram showing an example of a configuration of a decoding device according to one embodiment.

FIG. 12 is a block diagram showing an example of a configuration of a decoding processing unit according to one embodiment.

FIG. 13 is a block diagram showing an example of a configuration of an IDCT determination unit according to one embodiment.

FIG. 14 is a flowchart showing an example of a processing flow of a Q value determination unit according to one embodiment.

FIG. 15 is a block diagram showing an example of a configuration of a decoding device according to one embodiment.

FIG. 16 is a block diagram showing an example of a configuration of a decoding processing unit according to one embodiment.

FIG. 17 is a block diagram showing an example of a configuration of an IDCT determination unit according to one embodiment.

FIG. 18 is a flowchart showing an example of a processing flow of an encoding type determination unit according to one embodiment.

### DETAILED DESCRIPTION

Prior to descriptions of embodiments, the background leading to the following embodiments will be described. The present inventor has investigated a method for realizing high-speed decoding processing by stopping the method of creating the inverse orthogonal matrix by rearranging the column vectors described in Patent Document 1, and by performing the IDCT processing by switching between two types of IDCT processing units in accordance with the decoded transform coefficient matrix.

The decoding device investigated by the present inventor has a decoding processing unit and a two-dimensional IDCT processing unit. The decoding processing unit performs decoding processing on encoded data obtained by encoding for each block of 8×8 pixels. The decoding processing unit rearranges a transform coefficient sequence obtained by decoding processing into two dimensions using a form of a zigzag scan matrix, and generates a transform coefficient matrix which is spatial frequency data.

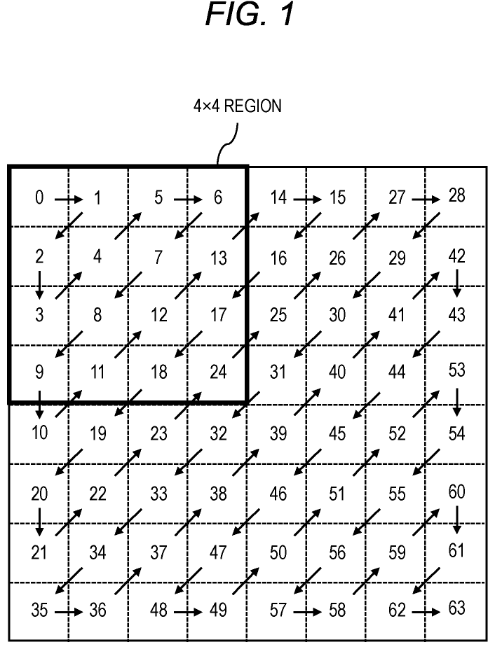

FIG. 1 is a diagram for explaining a scan order of a zigzag scan matrix. FIG. 1 shows an 8×8 matrix having 64 elements with 8×8=64 squares. Numbers 0 to 63 (scan numbers) and arrows shown in FIG. 1 show the scan order of the zigzag scan matrix. The decoding processing unit generates a transform coefficient matrix with 8×8 elements by rearranging the transform coefficient sequence obtained by the decoding processing into locations according to the scan numbers shown in the zigzag scan matrix of FIG. 1.

The data obtained by the decoding includes End-Of-Block (EOB) information indicating the end of the block. The EOB information is information indicating the location of the last coefficient which is not 0, i.e., the last valid coefficient, in the transform coefficient matrix rearranged in the form of the zigzag scan matrix shown in FIG. 1, and is indicated by the scan number in FIG. 1. For example, if the EOB information indicates the scan number 20, all the coefficients after the scan number 21 are 0.

The two-dimensional IDCT processing unit receives a transform coefficient matrix with 8×8 elements and EOB-information from the decoding processing unit. The two-dimensional IDCT processing unit includes an 8×8 IDCT processing unit and a 4×4 IDCT processing unit, and can perform two types of IDCT processing on the received transform coefficient matrix.

The 8×8 IDCT processing unit performs IDCT processing using all the elements of the received transform coefficient matrix with the 8×8 elements as effective elements. Hereinafter, the transform coefficient matrix with the 8×8 elements is also referred to as an 8×8 transform coefficient matrix. The IDCT processing performed using the 8×8 elements as the effective elements is also referred to as 8×8 IDCT processing.

On the other hand, the 4×4 IDCT processing unit performs IDCT processing using 4×4 elements located in a low frequency side region of the received transform coefficient matrix with the 8×8 elements, as effective elements. The low frequency side region where the 4×4 element is located corresponds to, for example, a 4×4 region shown in FIG. 1. Hereinafter, the transform coefficient matrix with the 4×4 elements is also referred to as a 4×4 transform coefficient matrix. The IDCT processing performed using the 4×4 elements as the effective element is also referred to as a 4×4 IDCT processing.

The two-dimensional IDCT processing unit determines whether or not there is a coefficient which is not 0 outside the 4×4 region in FIG. 1 based on the EOB information, and performs either the 8×8 IDCT processing or the 4×4 IDCT processing based on the result of the determination.

More specifically, when the scan number indicated in the EOB information is less than 10, the two-dimensional IDCT processing unit determines that the coefficients that are not 0, that is, all of the effective coefficients are inside the 4×4 region, and performs the 4×4 IDCT processing by the 4×4 IDCT processing unit. On the other hand, when the scan number indicated in the EOB information is 10 or more, the two-dimensional IDCT processing unit determines that the coefficient which is not 0, i.e., the effective coefficient, is outside the 4×4 region, and performs the 8×8 IDCT processing by the 8×8 IDCT processing unit.

In this manner, the two-dimensional IDCT processing unit performs the IDCT processing by switching between the 8×8 IDCT processing unit and the 4×4 IDCT processing unit based on the EOB information. In the 4×4 IDCT processing, the calculation amount is reduced to half or less of that in the 8×8 IDCT processing. If all of the coefficients outside the 4×4 region are 0, the result of the 4×4 IDCT processing will be the same as that of the 8×8 IDCT processing. In other words, the 4×4 IDCT processing is performed instead of the 8×8 IDCT processing in accordance with the distribution state of the transform coefficients, thereby speeding up the decoding processing.

However, in the method of performing the IDCT processing by switching between the 8×8 IDCT processing unit and the 4×4 IDCT processing unit based on the EOB information, depending on the coefficient distribution of the 8×8 transform coefficient matrix, it may not be possible to enjoy the advantage of speeding up by the 4×4 IDCT processing.

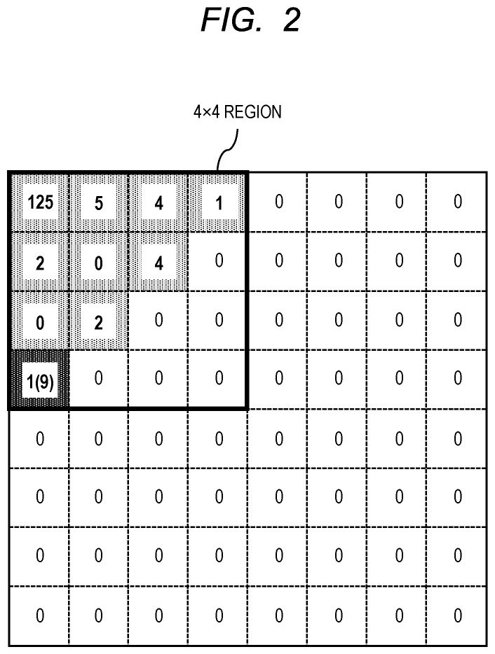

FIG. 2 is a diagram showing an example of the coefficient distribution of the 8×8 transform coefficient matrix when the EOB information indicates the scan number 9. “1(9)” in FIG. 2 indicates that the coefficient 1 of the scan number 9 is the last coefficient which is not 0 in the 8×8 transform coefficient matrix shown in FIG. 2.

In the case of the coefficient distribution shown in FIG. 2, since the EOB information indicates the scan number 9, the 4×4 IDCT processing unit is selected. Since all of the coefficients outside the 4×4 region are 0, the 4×4 IDCT processing speeds up the decoding processing.

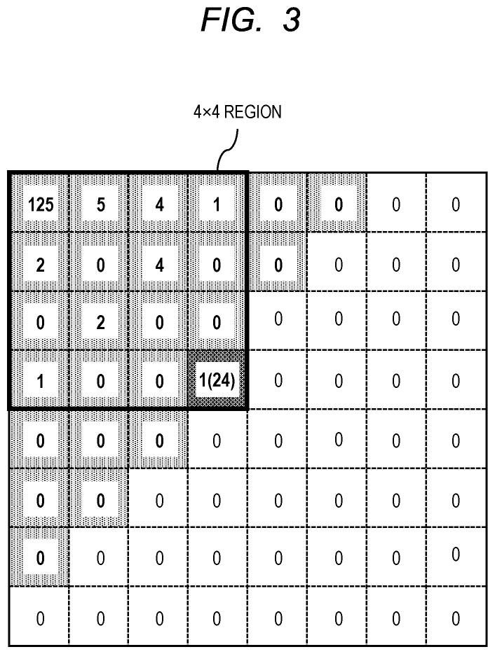

On the other hand, FIG. 3 is a diagram showing an example of the coefficient distribution of the 8×8 transform coefficient matrix when the EOB information indicates the scan number 24. “1(24)” in FIG. 3 indicates that the coefficient 1 of the scan number 24 is the last coefficient which is not 0 in the 8×8 transform coefficient matrix shown in FIG. 3.

In the case of the coefficient distribution shown in FIG. 3, since the EOB information indicates the scan number 24, the 8×8 IDCT processing is selected. However, as shown in FIG. 3, since all of the coefficients outside the 4×4 region are 0, the 4×4 IDCT processing should be applied originally. That is, in the example of the coefficient distribution shown in FIG. 3, since the 8×8 IDCT processing unit and the 4×4 IDCT processing unit are switched only by the EOB information, the coefficient distribution cannot enjoy the advantage of the high-speed processing by the 4×4 IDCT processing. In order to properly switch between the 8×8 IDCT processing unit and the 4×4 IDCT processing unit, not only the EOB information but also the coefficient distributions of the 8×8 transform coefficient matrix need to be accurately grasped.

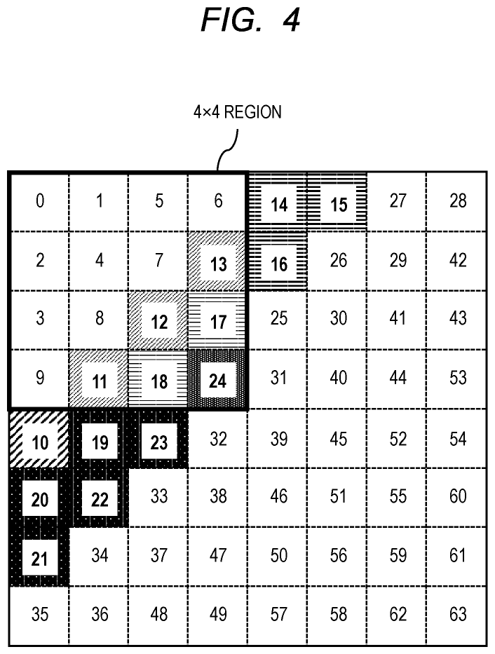

FIG. 4 is a diagram for explaining zero-coefficient determination processing in the case where the EOB information indicates the scan number 11 to 13, 17, 18, or 24. As shown in FIG. 4, when the EOB information indicates 11, 12, or 13, the two-dimensional IDCT processing unit determines whether or not the coefficient of the scan number 10, which is the coefficient outside the 4×4 region, is 0. If the coefficient of the scan number 10 is 0, the two-dimensional IDCT processing unit can select the 4×4 IDCT processing unit.

When the EOB information indicates 17 or 18, the two-dimensional IDCT processing unit determines whether or not all of the coefficients of the scan numbers 10, and 14 to 16, which are the coefficients outside the 4×4 region, are 0. If all of the coefficients of the scan numbers 10, and 14 to 16 are 0, the two-dimensional IDCT processing unit can select the 4×4 IDCT processing unit.

When the EOB information indicates 24, the two-dimensional IDCT processing unit determines whether or not all of the coefficients of the scan numbers 10, 14 to 16, and 19 to 23, which are the coefficients outside the 4×4 region are 0. If all of the coefficients of the scan numbers 10, 14, to 16, and 19 to 23 are 0, the two-dimensional IDCT processing unit can select the 4×4 IDCT processing unit.

As described above, when the EOB information indicates the scan number 11 to 13, 17, 18, or 24, the two-dimensional IDCT processing unit can accurately grasp the coefficient distribution of the 8×8 transform coefficient matrix by determining whether or not the coefficients outside the 4×4 region are 0. As a result, the two-dimensional IDCT processing unit can appropriately switch between the 8×8 IDCT processing unit and the 4×4 IDCT processing unit.

However, the processing amount is increased by the zero-coefficient determination processing of whether or not the coefficients outside the 4×4 region are 0. In particular, when the EOB information indicates the scan number 24, the zero-coefficient determination processing for the 9 coefficients of the scan numbers 10, 14 to 16, and 19 to 23 becomes necessary, and the processing amount increases remarkably. In this instance, even if the 8×8 IDCT processing unit and the 4×4 IDCT processing unit can be appropriately switched, there is a possibility that the merit of the speed-up by the 4×4 IDCT processing may be offset by the increase in the processing amount of the zero-coefficient determination processing. Further, depending on image data to be processed, not only the merit of the high-speed by the 4×4 IDCT processing is offset, but also the decoding processing is delayed in some cases. The present inventor has investigated a decoding device capable of reducing the processing amount for accurately grasping the coefficient distribution of the 8×8 transform coefficient matrix while improving the utilization rate of 4×4 IDCT processing, and as a result, the following embodiments have been conceived.

Hereinafter, a decoding device according to on embodiment will be described in detail by referring to the drawings. In the specification and the drawings, the same or corresponding components are denoted by the same reference numerals, and a repetitive description thereof is omitted. In the drawings, for convenience of description, the configuration may be omitted or simplified. Also, each of the embodiments may be optionally combined with at least some of the other embodiments.

### First Embodiment

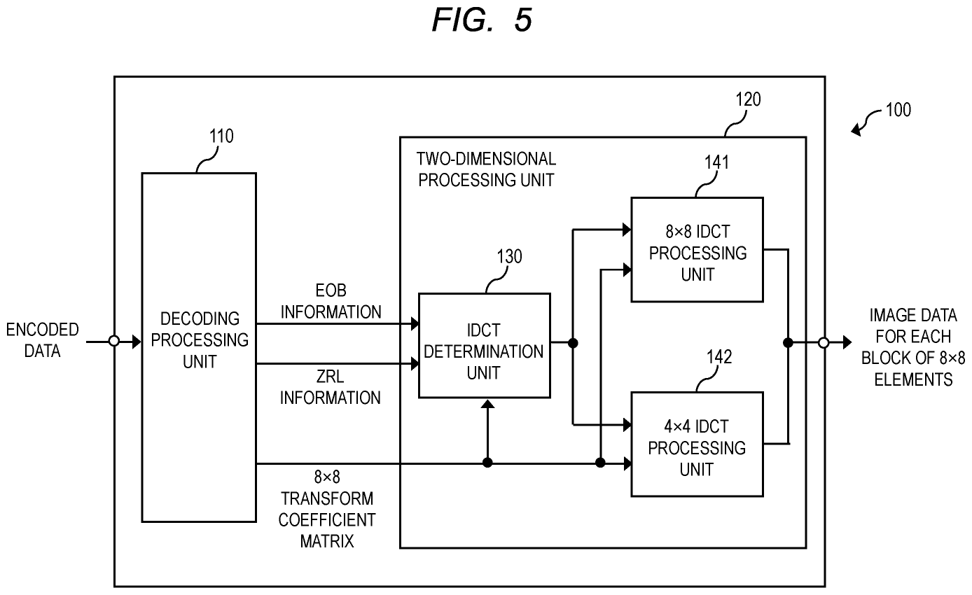

FIG. 5 is a block diagram showing an example of a configuration of a decoding device according to a first embodiment. As shown in FIG. 5, a decoding device 100 receives encoded data on which DCT processing for each block of 8×8 pixels is performed and then which is encoded by an encoding device. The decoding device 100 performs decoding processing and IDCT processing on the received encoded data to restore image data for each block 8×8 pixels. The decoding device 100 outputs the restored image data for each block of the 8×8 pixels.

The decoding device 100 includes a decoding processing unit 110 and a two-dimensional IDCT processing unit 120. The decoding processing unit 110 performs decoding processing on the encoded data to generate a decoded transform coefficient sequence. The decoding processing unit 110 rearranges the decoded transform coefficient sequence at the location according to the scan numbers shown in the zigzag scan matrix of FIG. 1, and generates an 8×8 transform coefficient matrix which is spatial frequency data. The decoding processing unit 110 is connected to the two-dimensional IDCT processing unit 120, and outputs the generated 8×8 transform coefficient matrix to the two-dimensional IDCT processing unit 120.

The decoding processing unit 110 also outputs EOB information and Zero-Run-Length (ZRL) information to the two-dimensional IDCT processing unit 120. The EOB information and the ZRL information are information obtained by decoding the encoded data. As described above, The EOB information is information indicating the location of the last coefficient which is not 0, i.e., the last effective coefficient, in the transform coefficient matrix rearranged in the form of the zigzag scan matrix, and is indicated by the scan number.

On the other hand, the ZRL information is information indicating the number of coefficients which is 0 between the last coefficient which is not 0 and indicated by the EOB information, and a coefficient which is not 0 and located immediately before the last coefficient which is not 0. For example, in the example of the 8×8 transform coefficient matrix shown in FIG. 2, since the EOB information indicates the scan number 9 and the coefficient which is not 0 and located immediately before the scan number 9 is the scan number 8, the number of coefficients which is 0 and between the coefficient (1) of the scan number 9 and the coefficient (2) of the scan number 8 is 0. Therefore, the ZRL information is 0.

Further, in the example of the 8×8 transform coefficient matrix shown in FIG. 3, since the EOB information indicates the scan number 24 and the coefficient which is not 0 and located immediately before the scan number 24 is the scan number 9, the number of coefficients which is 0 and between the coefficient (1) of the scan number 24 and the coefficient (1) of the scan number 9 is 14. Therefore, the ZRL information is 14.

The two-dimensional IDCT processing unit 120 includes an IDCT determination unit 130, an 8×8 IDCT processing unit 141, and a 4×4 IDCT processing unit 142. The IDCT determination unit 130 is connected to the decoding processing unit 110, and receives an 8×8 transform coefficient matrix, EOB information, and ZRL information. The IDCT determination unit 130 determines the number of elements in the row direction and the column direction required to select the 8×8 IDCT processing or the 4×4 IDCT processing based on the 8×8 transform coefficient matrix, the EOB information, and the ZRL information. The IDCT determination unit 130 generates a selection signal for selecting one of the 8×8 IDCT processing and the 4×4 IDCT processing based on the determined number of elements in the row direction and the column direction. The generated selection signal is output to the 8×8 IDCT processing unit 141 and the 4×4 IDCT processing unit 142.

The 8×8 IDCT processing unit 141 is connected to the decoding processing unit 110 and the IDCT determination unit 130. When the 8×8 IDCT processing unit 141 receives the selection signal indicating that the 8×8 IDCT processing is to be performed from the IDCT determination unit 130, the 8×8 IDCT processing unit 141 performs the IDCT processing using, as effective elements, all the elements of the transform coefficient matrix with the 8×8 elements received from the decoding processing unit 110. The 8×8 IDCT processing unit 141 performs the 8×8 IDCT processing on the 8×8 transform coefficient matrix to restore image data for each block of 8×8 pixels.

The 4×4 IDCT processing unit 142 is connected to the decoding processing unit 110 and the IDCT determination unit 130. When the 4×4 IDCT processing unit 142 receives the selection signal indicating that the 4×4 IDCT processing is to be performed from the IDCT determination unit 130, the 4×4 IDCT processing unit 142 performs the IDCT processing using, as effective elements, the 4×4 elements located in the low frequency side region of the transform coefficient matrix with the 8×8 elements received from the decoding processing unit 110. The low frequency side region corresponds to, for example, the 4×4 region shown in FIG. 1. The 4×4 IDCT processing unit 142 restores image data for each block of the 8×8 pixels by performing the 4×4 IDCT processing on the 8×8 transform coefficient matrix.

As described above, the 8×8 IDCT processing unit 141 and the 4×4 IDCT processing unit 142 selectively perform the 8×8 IDCT processing or the 4×4 IDCT processing on the 8×8 transform coefficient matrix based on the determination result by the IDCT determination unit 130, and restore the image data for each block of the 8×8 pixels.

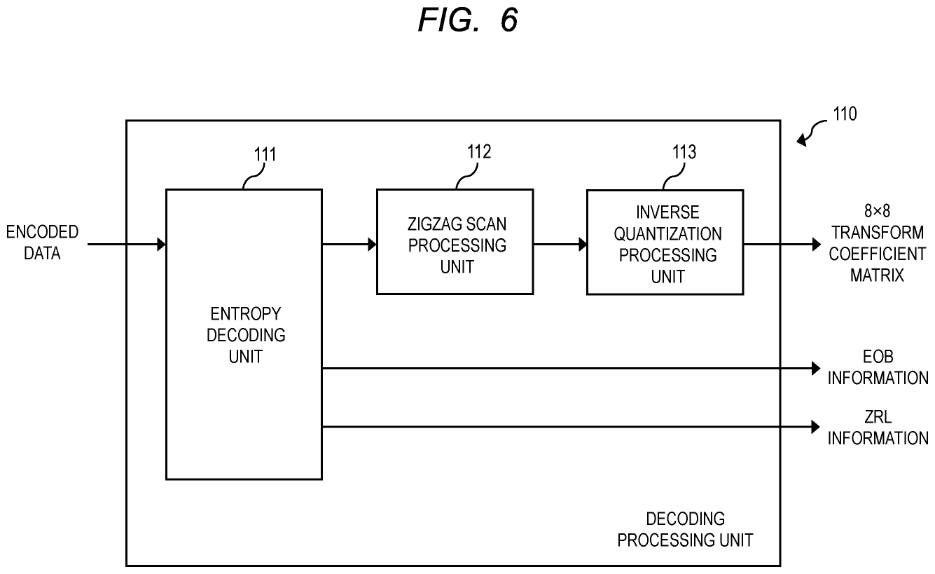

FIG. 6 is a block diagram showing an example of a configuration of the decoding processing unit 110 according to the first embodiment. As shown in FIG. 6, the decoding processing unit 110 includes an entropy decoding unit 111, a zigzag scan processing unit 112, and an inverse quantization processing unit 113.

The entropy decoding unit 111 receives an entropy encoded sequence which is encoded data obtained by entropy encoding processing. The entropy encoded sequence is encoded using, for example, a Huffman code which is a type of entropy encoding. In this case, the entropy decoding unit 111 performs decoding processing of a Huffman code on the received entropy encoded sequence. The entropy decoding unit 111 is connected to the zigzag scan processing unit 112, and outputs the decoded transform coefficient sequence to the zigzag scan processing unit 112. The entropy decoding unit 111 outputs the EOB information and the ZRL information obtained by decoding the encoded data to the two-dimensional IDCT processing unit 120.

The zigzag scan processing unit 112 receives the decoded transform coefficient sequence from the entropy decoding unit 111. The zigzag scan processing unit 112 rearranges the decoded transform coefficient sequence into the location according to the scan numbers shown in the zigzag scan matrix of FIG. 1, and generates an 8×8 transform coefficient matrix. The zigzag scan processing unit 112 is connected to the inverse quantization processing unit 113, and outputs the generated 8×8 transform coefficient matrix to the inverse quantization processing unit 113.

In the MPEG method and the JPEG method, an encoding device performs quantization processing by dividing each element of a transform coefficient matrix after DCT processing is performed by each element of a quantization matrix. As a result, the data is compressed. Therefore, the inverse quantization processing unit 113 performs inverse quantization processing using the quantization matrix used in encoding.

Specifically, the inverse quantization processing unit 113 performs inverse quantization processing by multiplying each element of the 8×8 transform coefficient matrix received from the zigzag scan processing unit 112 by each element of the quantization matrix with the 8×8 elements, and generates an 8×8 transform coefficient matrix which is inversely quantized and spatial frequency data. The generated 8×8 transform coefficient matrix is output to the two-dimensional IDCT processing unit 120.

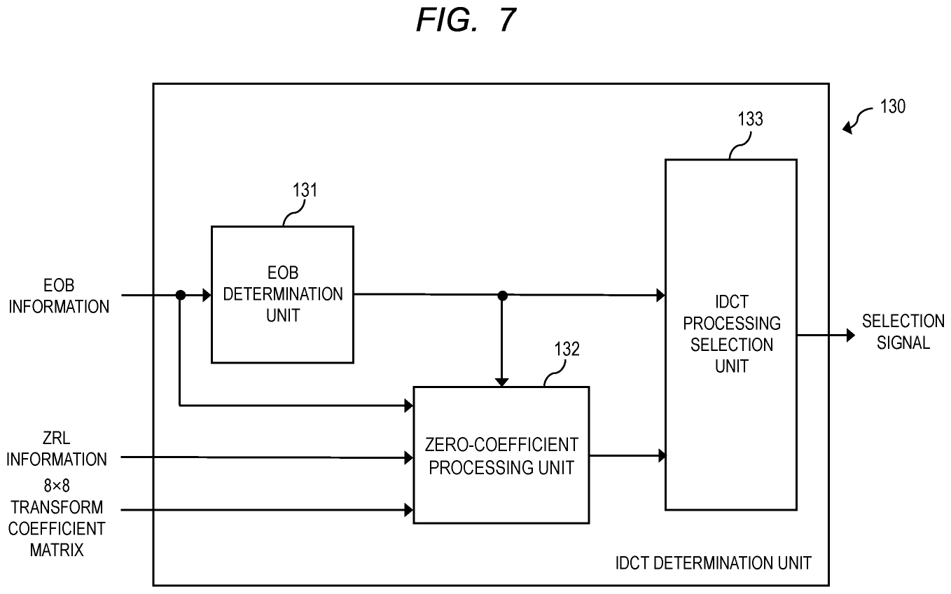

FIG. 7 is a block diagram showing an example of a configuration of the IDCT determination unit 130 according to the first embodiment. As shown in FIG. 7, the IDCT determination unit 130 includes an EOB determination unit 131, a zero-coefficient determination unit 132, and an IDCT processing selection unit 133.

The EOB determination unit 131 is connected to the decoding processing unit 110, the zero-coefficient determination unit 132, and IDCT processing selection unit 133. The EOB determination unit 131 determines whether to perform any of the 8×8 IDCT processing, the 4×4 IDCT processing, and zero-coefficient determination processing based on the EOB information received from the decoding processing unit 110, The EOB determination unit 131 outputs the determination result to the zero-coefficient determination unit 132 and the IDCT processing selection unit 133 as an EOB determination result.

The zero-coefficient determination unit 132 is connected to the decoding processing unit 110, the EOB determination unit 131, and the IDCT processing selection unit 133. When the zero-coefficient determination unit 132 receives the EOB determination result indicating that the zero-coefficient determination processing is to be performed from the EOB determination unit 131, the zero-coefficient determination unit 132 determines whether to perform either the 8×8 IDCT processing or the 4×4 IDCT processing based on the 8×8 transform coefficient matrix, the EOB information, and the ZRL information received from the decoding processing unit 110. The zero-coefficient determination unit 132 outputs the determination result to the IDCT processing selection unit 133 as a zero-coefficient determination result.

The IDCT processing selection unit 133 is connected to the EOB determination unit 131, the zero-coefficient determination unit 132, the 8×8 IDCT processing unit 141, and the 4×4 IDCT processing unit 142. When the IDCT processing selection unit 133 receives the EOB determination result indicating that the 8×8 IDCT processing is to be performed from the EOB determination unit 131 or the zero-coefficient determination result indicating that the 8×8 IDCT processing is to be performed from the zero-coefficient determination unit 132, the IDCT processing selection unit 133 generates a selection signal indicating that the 8×8 IDCT processing is to be performed. On the other hand, when the IDCT processing selection unit 133 receives the EOB determination result indicating that the 4×4 IDCT processing is to be performed from the EOB determination unit 131 or the zero-coefficient determination result indicating that the 4×4 IDCT processing is to be performed from the zero-coefficient determination unit 132, the IDCT processing selection unit 133 generates a selection signal indicating that the 4×4 IDCT processing is to be performed. The generated selection signal is output to the 8×8 IDCT processing unit 141 and the 4×4 IDCT processing unit 142.

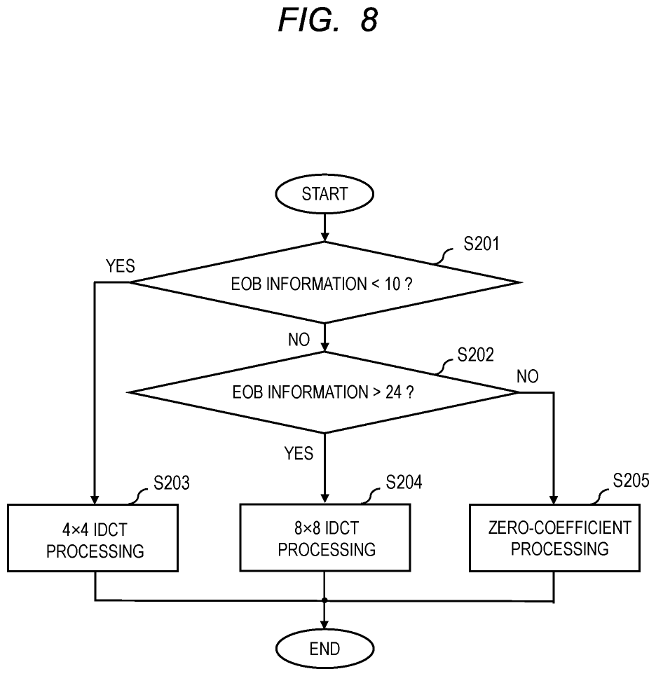

FIG. 8 is a flowchart showing an example of a processing flow of the EOB determination unit 131 according to the first embodiment. As shown in FIG. 8, in a step S201, the EOB determination unit 131 checks EOB information received from the decoding processing unit 110, and determines whether or not the scan number indicated in the EOB information is less than 10. When it is determined that the scan number indicated in the EOB information is less than 10 (YES in the step S201), the processing proceeds to a step S203. On the other hand, when it is determined that the scan number indicated in the EOB information is not less than 10 (NO in the step S201), the processing proceeds to a step S202.

For example, as shown in FIG. 4, the scan number 10 corresponds to the minimum scan number among the scan numbers of the coefficients outside the 4×4 region, i.e., not included in the 4×4 elements. Therefore, the processing of the step S201 is processing of determining whether or not the scan number indicated in the EOB information is less than the minimum scan number among the scan numbers of the coefficients not included in the 4×4 elements.

In the step S202, the EOB determination unit 131 checks EOB information received from the decoding processing unit 110, and determines whether or not the scan number indicated in the EOB information is more than 24. When it is determined that the scan number indicated in the EOB information is more than 24 (YES in the step S202), the processing proceeds to a step S204. On the other hand, when it is determined that the scan number indicated in the EOB information is not more than 24 (NO in the step S202), the processing proceeds to a step S205.

For example, as shown in FIG. 4, the scan number 24 corresponds to the maximum scan number among the scan numbers of the coefficients inside the 4×4 region, that is, the coefficients included in the 4×4 elements. Therefore, the processing of the step S202 is processing of determining whether or not the scan number indicated in the EOB information is more than the maximum scan number among the scan numbers of the coefficients included in the 4×4 elements.

In the step S203, the EOB determination unit 131 determines the processing to be performed as the 4×4 IDCT processing. For example, in FIG. 4, when the scan number indicated in the EOB information is less than 10, the coefficients which are not 0 exist only inside the 4×4 region, and do not exist outside the 4×4 region. Therefore, when the scan number indicated in the EOB information is less than 10, the processing to be performed is determined to be the 4×4 IDCT processing.

In the step S204, the EOB determination unit 131 determines the processing to be performed as the 8×8 IDCT processing. For example, in FIG. 4, when the scan number indicated in the EOB information is more than 24, the coefficients which are not 0 exist not only inside the 4×4 region but also outside the 4×4 region. Therefore, when the scan number indicated in the EOB information is more than 24, the processing to be performed is determined to be the 8×8 IDCT processing.

In the step S205, the EOB determination unit 131 determines the processing to be performed as the zero-coefficient determination processing. For example, in FIG. 4, when the scan number indicated in the EOB information is any one of 10 to 24, in order to determine whether or not a coefficient which is not 0 exists outside the 4×4 region, it is necessary to determine whether or not the coefficients of the scan numbers 10, 14 to 16, and 19 to 23 which are outside the 4×4 region are 0. That is, when the scan number indicated in the EOB information is any one of 10 to 24, whether the processing to be executed is the 8×8 IDCT processing or the 4×4 IDCT processing cannot be determined by the EOB information only, and the zero-coefficient determination processing is required.

As described above, in the processing flow of the EOB determination unit 131 shown in FIG. 8, the EOB determination unit 131 determines whether or not the scan number indicated in the EOB information is less than 10, in other words, less than the minimum scan number among the scan numbers of the coefficients not included in the 4×4 elements. If the determination result is YES, the EOB determination unit 131 determines that the 4×4 IDCT processing is to be performed. The EOB determination unit 131 determines whether or not the scan number indicated in the EOB information is more than 24, in other words, more than the maximum scan number among the scan numbers of the coefficients included in the 4×4 elements. If the determination result is YES, the EOB determination unit 131 determines that the 8×8 IDCT processing is to be performed. In these determination processing, if any of the determination results is NO, the EOB determination unit 131 determines that the zero-coefficient determination processing is to be performed. When any of the determination results are NO, it is equivalent to the case where the determination result is YES as to whether or not the scan number indicated in the EOB information is 10 or more and 24 or less, in other words, whether or not the scan number indicated in the EOB information is equal to or more than the minimum scan number not included in the 4×4 elements and equal to or less than the maximum scan number included in the 4×4 elements.

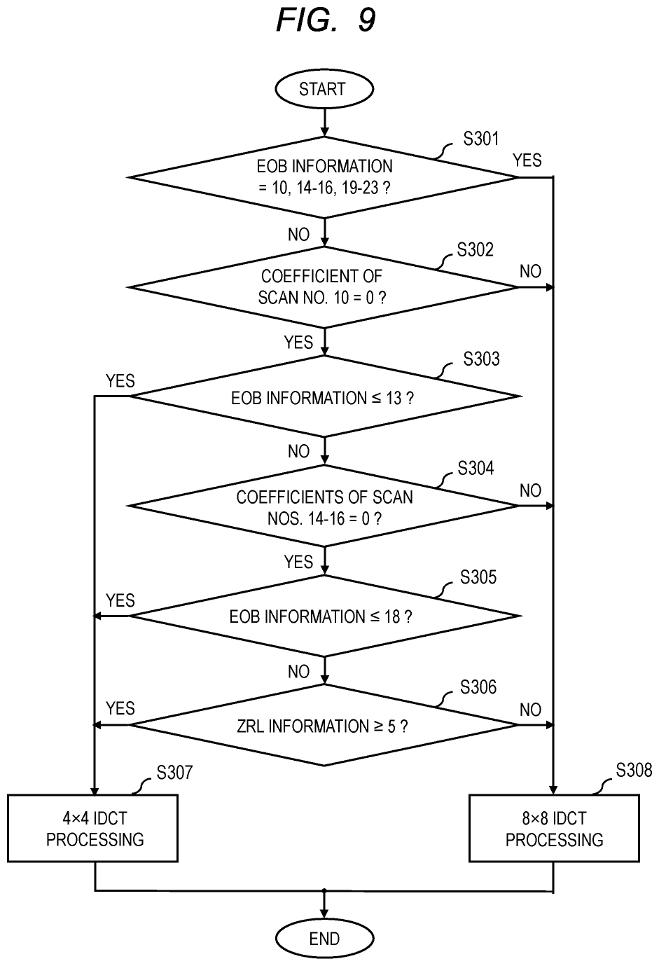

FIG. 9 is a flowchart showing an example of a processing flow of the zero-coefficient determination unit 132 according to the first embodiment. As shown in FIG. 9, in a step S301, the zero-coefficient determination unit 132 confirms EOB information received from the decoding processing unit 110, and determines whether or not the scan number indicated in the EOB information is any of 10, 14 to 16, and 19 to 23. When it is determined that the scan number indicated in the EOB information is any of 10, 14 to 16, and 19 to 23 (YES in the step S301), the processing proceeds to a step S308. On the other hand, when it is determined that the scan number indicated in the EOB information is not any of 10, 14 to 16, and 19 to 23 (NO in the step S301), the processing proceeds to a step S302.

In the step S308, the zero-coefficient determination unit 132 determines the processing to be performed as the 8×8 IDCT processing. If the processing of the step S301 is YES, for example, in FIG. 4, since the coefficient which is not 0 exists in any of the scan numbers 10, 14 to 16, and 19 to 23, that is, the coefficient which is not 0 exists outside the 4×4 region, the processing to be performed is determined to be the 8×8 IDCT processing.

In the step S302, the zero-coefficient determination unit 132 determines whether or not the coefficient of the scan number 10 is 0. If it is determined that the coefficient of the scan number 10 is 0 (YES in the step S302), the processing proceeds to a step S303. On the other hand, when it is determined that the coefficient of the scan number 10 is not 0 (NO in the step S302), the processing proceeds to the step S308.

When the processing of the step S302 is NO, for example, in FIG. 4, since the coefficient which is not 0 exists in the scan number 10 outside the 4×4 region, the processing to be performed is determined to be the 8×8 IDCT processing.

In the step S303, the zero-coefficient determination unit 132 confirms the EOB information received from the decoding processing unit 110, and determines whether or not the scan number indicated in the EOB information is 13 or less. If it is determined that the scan number indicated in the EOB information is 13 or less (YES in the step S303), the processing proceeds to a step S307. On the other hand, when it is determined that the scan number indicated in the EOB information is not 13 or less (NO in the step S303), the processing proceeds to step a S304.

In the step S307, the zero-coefficient determination unit 132 determines the processing to be performed as the 4×4 IDCT processing. If the processing of the step S303 is YES, for example, in FIG. 4, since the scan number indicated in the EOB information is any of 11 to 13 and the coefficient of the scan number 10 is 0, that is, the coefficient which is not 0 does not exist outside the 4×4 region, the processing to be executed is determined to be the 4×4 IDCT processing.

In the step S304, the zero-coefficient determination unit 132 determines whether or not all of the coefficients of the scan numbers 14 to 16 are 0. When it is determined that all of the coefficients of the scan numbers 14 to 16 are 0 (YES in the step S304), the processing proceeds to a step S305. On the other hand, when it is determined that all of the coefficients of the scan numbers 14 to 16 are not 0 (NO in the step S304), the processing proceeds to the step S308.

When the processing of the step S304 is NO, for example, in FIG. 4, since the coefficient which is 0 exists in any of the scan numbers 14 to 16 outside the 4×4 region, the processing to be performed is determined to be the 8×8 IDCT processing.

In the step S305, the zero-coefficient determination unit 132 confirms the EOB information received from the decoding processing unit 110, and determines whether or not the scan number indicated in the EOB information is 18 or less. When it is determined that the scan number indicated in the EOB information is 18 or less (YES in the step S305), the processing proceeds to the step S307. On the other hand, when it is determined that the scan number indicated in the EOB information is not 18 or less (NO in the step S305), the processing proceeds to a step S306.

If the processing of the step S305 is YES, for example, in FIG. 4, since the scan number indicated in the EOB information is either 17 or 18, and all of the coefficients of the scan numbers 10 and 14 to 16 are 0, that is, the coefficient which is not 0 does not exist outside the 4×4 region, the processing to be performed is determined to be the 4×4 IDCT processing. In the step S306, the zero-coefficient determination unit 132 confirms ZRL information received from the decoding processing unit 110, and determines whether or not the ZRL information is 5 or more. If it is determined that the ZRL information is 5 or more (YES in the step S306), the processing proceeds to the step S307. On the other hand, when it is determined that the ZRL information is not 5 or more (NO in the step S306), the processing proceeds to the step S308.

If the processing of the step S306 is YES, for example, in FIG. 4, the scan number indicated in the EOB information is 24, and all of the coefficients of the scan numbers 10 and 14 to 16 are 0. Furthermore, since the ZRL information is 5 or more, 5 or more coefficients which are 0 are continuous between the last coefficient which is not 0 and indicated in the EOB information (the coefficient of the scan number 24), and the coefficient which is not 0 and located immediately before the last coefficient. That is, the zero-coefficient determination unit 132 determines that all of the coefficients of the scan numbers 19 to 23 are 0. Therefore, since the coefficient which is not 0 does not exist outside the 4×4 region, the processing to be performed is determined to be the 4×4 IDCT processing.

On the other hand, when the processing of the step S306 is NO, for example, in FIG. 4, the scan number indicated in the EOB information is 24, and all of the coefficients of the scan numbers 10 and 14 to 16 are 0. However, since the ZRL information is not 5 or more, 5 or more coefficients which are 0 are not continuous between the last coefficient which is not 0 and indicated in the EOB information (the coefficient of the scan number 24), and the coefficient which is not 0 and located immediately before the last coefficient. That is, the zero-coefficient determination unit 132 determines that the coefficient which is not 0 exists in the coefficients of the scan numbers 19 to 23. Thus, since the coefficient which is not 0 exists outside the 4×4 region, the processing to be performed is determined to be the 8×8 IDCT processing.

As described above, the zero-coefficient determination processing based on the ZRL information is performed on the coefficients of the scan numbers 19 to 23 when the EOB information indicates the scan number 24. For example, as shown in FIG. 4, the scan number 24 is inside the 4×4 region, that is, corresponds to the maximum scan number among the scan numbers of the coefficients included in the 4×4 elements. Also, for example, as shown in FIG. 4, the coefficients of scan numbers 19 to 23 are located between the coefficient of the scan number 24 and the coefficient of the scan number 18 which is inside the 4×4 region, that is, included in the 4×4 elements. In other words, the coefficients of the scan numbers 19 to 23 are located between the coefficient of the maximum scan number (24) which is included in the 4×4 elements, and the coefficient of the scan number (18) which is located immediately before the coefficient of the maximum scan number and included in the 4×4 elements.

Therefore, when the scan number indicated in the EOB information is the maximum scan number among the scan numbers included in the 4×4 elements, the zero-coefficient determination unit 132 determines whether or not all of the coefficients of the scan numbers between the coefficient of the maximum scan number and the coefficient of the scan number which is located immediately before the coefficient of the maximum scan number and included in the 4×4 elements are 0 based on the ZRL information.

When it is determined that all of the coefficients of the scan numbers between the coefficient of the maximum scan number and the coefficient of the scan number which is located immediately before the coefficient of the maximum scan number and included in the 4×4 elements are 0, the zero-coefficient determination unit 132 determines that the 4×4 IDCT processing is to be performed.

On the other hand, when it is determined that all of the coefficients of the scan numbers between the coefficient of the maximum scan number and the coefficient of the scan number which is located immediately before the coefficient of the maximum scan number and included in the 4×4 elements are not 0, the zero-coefficient determination unit 132 determines that the 8×8 IDCT processing is to be performed.

As described above, in the decoding device 100 according to the first embodiment, the IDCT determination unit 130 determines the number of elements in the row direction and the column direction required to select the 8×8 IDCT processing or the 4×4 IDCT processing based on the 8×8 transform coefficient matrix, the EOB information, and the ZRL information received from the decoding processing unit 110. The 8×8 IDCT processing unit 141 and the 4×4 IDCT processing unit 142 selectively perform the 8×8 IDCT processing or the 4×4 IDCT processing on the 8×8 transform coefficient matrix in accordance with the selection signal generated based on the determination result by the IDCT determination unit 130, to restore the image data for each block of the 8×8 pixels.

In order to properly select one of the 8×8 IDCT processing and the 4×4 IDCT processing, the coefficient distribution of the 8×8 transform coefficient matrix need to be accurately grasped. For this purpose, it is required to perform the determination processing of whether or not the coefficients outside the 4×4 region are 0, that is, the zero-coefficient determination processing. Since the zero-coefficient determination processing is performed by a plurality of processing of accessing a memory region in which the coefficients are stored, reading the coefficients from the memory region, and comparing the read coefficients with 0, the processing amount increases. In particular, in the case where the EOB information indicates the scan number 24, zero-coefficient determination processing is required for the 9 coefficients of the scan numbers 10, 14 to 16, and 19 to 23 which are outside the 4×4 region, and the processing amount increases remarkably.

However, in the zero-coefficient determination processing of the coefficients of the scan numbers 19 to 23 by the decoding device 100 according to the first embodiment, the zero-coefficient determination processing is not individually performed for the coefficients of the scan numbers 19 to 23, and the zero-coefficient determination processing can be easily performed in one time processing by using the ZRL information. That is, the decoding device 100 according to the first embodiment can improve the utilization rate of the 4×4 IDCT processing by accurately grasping the distribution state of the 8×8 transform coefficient matrix and speed up the decoding processing while reducing the processing amount of the zero-coefficient determination processing by using the ZRL information.

In the above-described first embodiment, the example in which the 8×8 IDCT processing and the 4×4 IDCT processing are selectively performed on the 8×8 transform coefficient matrix using the 8×8 IDCT processing unit 141 and the 4×4 IDCT processing unit 142 has been described, but the present embodiment is not limited to this example. That is, m×n IDCT processing and p×q IDCT processing may be selectively performed on an m×n transform coefficient matrix using an m×n IDCT processing unit and a p×q IDCT processing unit. The m and p denote the number of elements in the row direction, and the n and q denote the number of elements in the column direction. Each variable of the m, n, p, and q may take on 2 or more natural numbers, and the relationship between the variables of the m, n, p, and q is either m>p and n≥q, or m≥p and n>q.

Therefore, the above-described first embodiment corresponds to m=n=8 and p=q=4. Further, if m=n=16 and p=q=8, this corresponds to the case where a 16×16 IDCT processing or an 8×8 IDCT processing is selectively performed on encoded data obtained by encoding for each block of 16×16 pixels to restore image data for each block of 16×16 pixels.

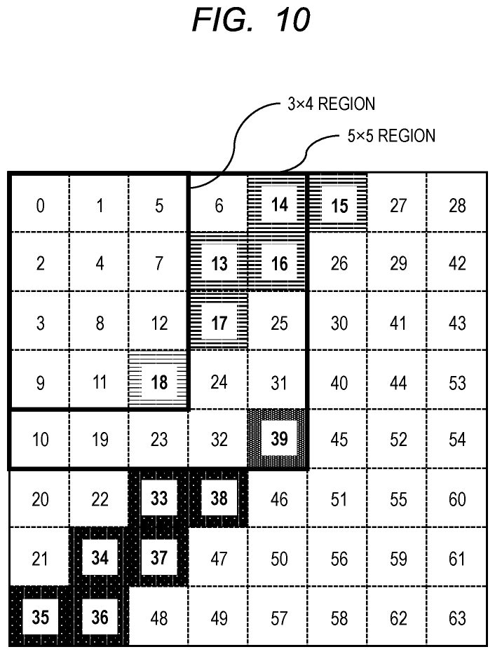

FIG. 10 is a diagram for explaining a plurality of examples of the zero-coefficient determination processing in the m×n IDCT processing and the p×q IDCT processing. As shown in FIG. 10, when m=n=8 and p=q=5, it is necessary to determine whether or not coefficients which are not 0 exist outside a 5×5 region. In particular, when EOB information indicates the scan number 39, the zero-coefficient determination processing based on ZRL information is performed on the coefficients of the scan numbers 33 to 38.

Further, as shown in FIG. 10, when m=n=8, p=3, and q=4, it is necessary to determine whether or not coefficients which are not 0 exist outside a 3×4 region. More specifically, when EOB information indicates the scan number 18, the zero-coefficient determination processing based on ZRL information is performed on the coefficients of the scan numbers 13 to 17. Incidentally, in FIG. 10, the example of m=n=8 is shown, but for example, the m may not be equal to the n such as 6×8.

In the above-described first embodiment, the scan order of the zigzag scan is described in the order shown in FIG. 1, but the scan order is not limited to that. For example, in FIG. 1, the scan order is from 0 to 1 in the row direction, but may be from 0 to 1 in the column direction. In this instance, the scan order of FIG. 1 is the order of “0, 2, 1, 5, 4, . . . ”.

In the above-described first embodiment, the two-dimensional IDCT processing unit 120 includes the 8×8 IDCT processing unit 141 and the 4×4 IDCT processing unit 142, and can perform two types of the IDCT processing including the 8×8 IDCT processing and the 4×4 IDCT processing, but the present embodiment is not limited to that. That is, three or more types of IDCT processing may be performed. For example, the two-dimensional IDCT processing unit 120 may be configured to perform three types of IDCT processing including 8×8 IDCT processing, 6×6 IDCT processing, and 4×4 IDCT processing.

### Second Embodiment

Next, a second embodiment will be described. In second embodiment, components having the same functions as those of first embodiment are denoted by the same reference numerals, and descriptions thereof are omitted.

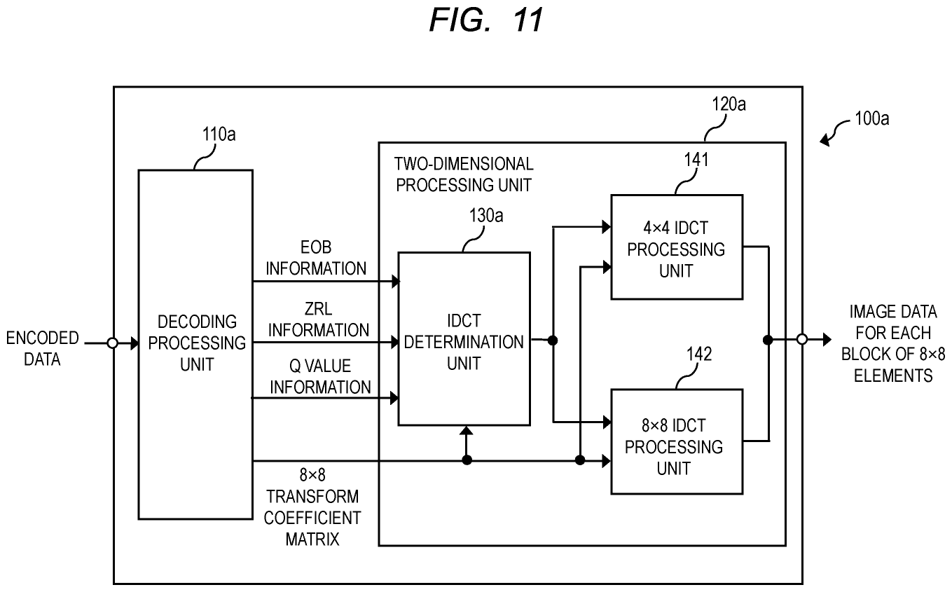

FIG. 11 is a block diagram showing an example of a configuration of a decoding device 100a according to the second embodiment. The decoding device 100a according to the second embodiment is another embodiment of the decoding device 100 according to the first embodiment. As shown in FIG. 11, the decoding device 100a includes a decoding processing unit 110a and a two-dimensional IDCT processing unit 120a.

The decoding processing unit 110a outputs quantized coefficient value (Q value) information to the two-dimensional IDCT processing unit 120a in addition to an 8×8 transform coefficient matrix, EOB information, and ZRL information.

The two-dimensional IDCT processing unit 120a includes an IDCT determination unit 130a, the 8×8 IDCT processing unit 141, and the 4×4 IDCT processing unit 142. The IDCT determination unit 130a is connected to the decoding processing unit 110a, the 8×8 IDCT processing unit 141, and the 4×4 IDCT processing unit 142. The IDCT determination unit 130a receives the Q value information in addition to the 8×8 transform coefficient matrix, the EOB information, and the ZRL information from the decoding processing unit 110a.

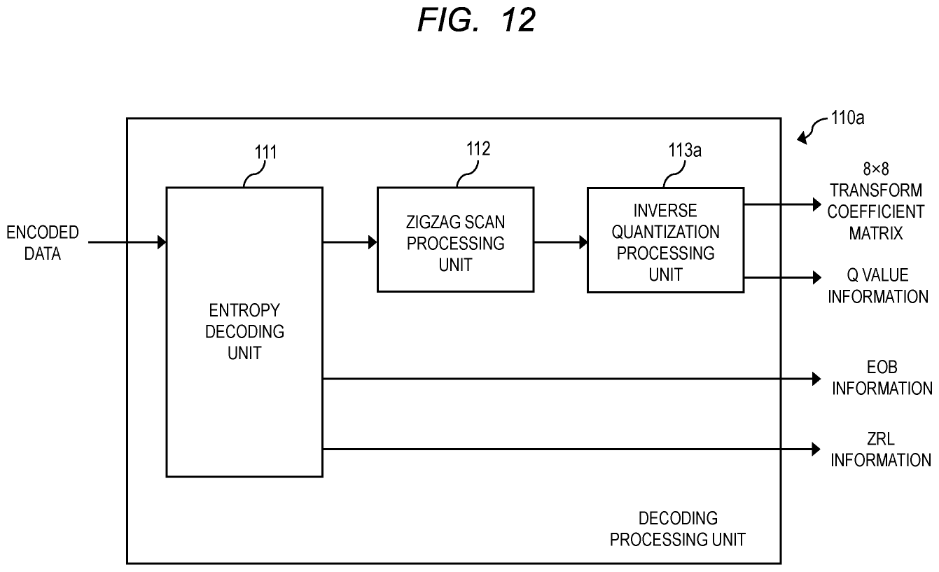

FIG. 12 is a block diagram showing an example of a configuration of the decoding processing unit 110a according to the second embodiment. As shown in FIG. 12, the inverse quantization processing unit 113 of FIG. 6 is changed to an inverse quantization processing unit 113a.

Each element of the quantization matrix used in performing the quantization processing and the inverse quantization processing is changed by the Q value in order to adjust the compression rate of the data amount of the transform coefficient. Generally, the larger the Q value, the larger the compression rate, and the smaller the Q value, the smaller the compression rate. When the Q value is large, the number of coefficients which are 0 and included in the transform coefficient matrix tends to increase, and when the Q value is small, the number of coefficients which are 0 and included in the transform coefficient matrix tends to decrease. That is, the distribution of the coefficients which are 0 and included in the transform coefficient matrix depends greatly on the Q value.

In addition to the 8×8 transform coefficient matrix generated by the inverse quantization processing, the inverse quantization processing unit 113a outputs the Q value used when performing the inverse quantization processing to the two-dimensional IDCT processing unit 120a as Q value information.

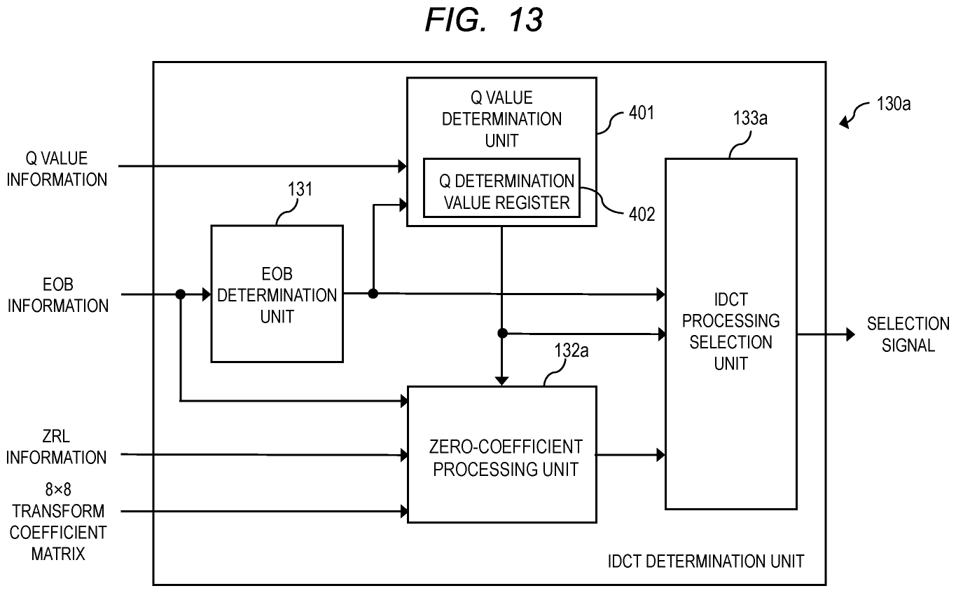

FIG. 13 is a block diagram showing an example of a configuration of the IDCT determination unit 130a according to the second embodiment. As shown in FIG. 13, the zero-coefficient determination unit 132 and the IDCT processing selection unit 133 of FIG. 7 are changed to a zero-coefficient determination unit 132a and an IDCT processing selection unit 133a, respectively. The IDCT determination unit 130a includes a Q value determination unit 401 in addition to the configuration of the IDCT determination unit 130 shown in FIG. 7.

The Q value determination unit 401 is connected to the decoding processing unit 110a, the EOB determination unit 131, the zero-coefficient determination unit 132a, and the IDCT processing selection unit 133a. The Q value determination unit 401 receives Q value information output from the decoding processing unit 110a and EOB determination result output from the EOB determination unit 131.

The Q value determination unit 401 includes a Q determination value register 402 for storing a Q determination value. When receiving the EOB determination result indicating that the zero-coefficient determination processing is to be performed from the EOB determination unit 131, the Q value determination unit 401 determines whether to perform either the 8×8 IDCT processing or the zero-coefficient determination processing based on the Q value obtained from the Q value information and the Q determination value stored in the Q determination value register 402. The Q value determination unit 401 outputs the determination result to the zero-coefficient determination unit 132a and the IDCT processing selection unit 133a as a Q value determination result.

The zero-coefficient determination unit 132a is connected to the decoding processing unit 110a, the Q value determination unit 401, and the IDCT processing selection unit 133a. When receiving the Q value determination result indicating that the zero-coefficient determination processing is to be performed from the Q value determination unit 401, the zero-coefficient determination unit 132a determines whether to perform either the 8×8 IDCT processing and the 4×4 IDCT processing based on the 8×8 transform coefficient matrix, the EOB information, and the ZRL information received from the decoding processing unit 110a. The zero-coefficient determination unit 132a outputs the determination result to the IDCT processing selection unit 133a as the zero-coefficient determination result.

The IDCT processing selection unit 133a is connected to the EOB determination unit 131, the Q value determination unit 401, the zero-coefficient determination unit 132a, the 8×8 IDCT processing unit 141, and the 4×4 IDCT processing unit 142. When receiving the EOB determination result indicating that the 8×8 IDCT processing is to be performed from the EOB determination unit 131, the Q value determination result indicating that the 8×8 IDCT processing is to be performed from the Q value determination unit 401, or the zero-coefficient determination result indicating that the 8×8 IDCT processing is to be performed from the zero-coefficient determination unit 132a, the IDCT processing selection unit 133a generates the selection signal indicating that the 8×8 IDCT processing is to be performed. On the other hand, when receiving the EOB determination result indicating that the 4×4 IDCT processing is to be performed from the EOB determination unit 131 or the zero-coefficient determination result indicating that the 4×4 IDCT processing is to be performed from the zero-coefficient determination unit 132a, the IDCT processing selection unit 133a generates the selection signal indicating that the 4×4 IDCT processing is to be performed. The generated selection signal is output to the 8×8 IDCT processing unit 141 and the 4×4 IDCT processing unit 142.

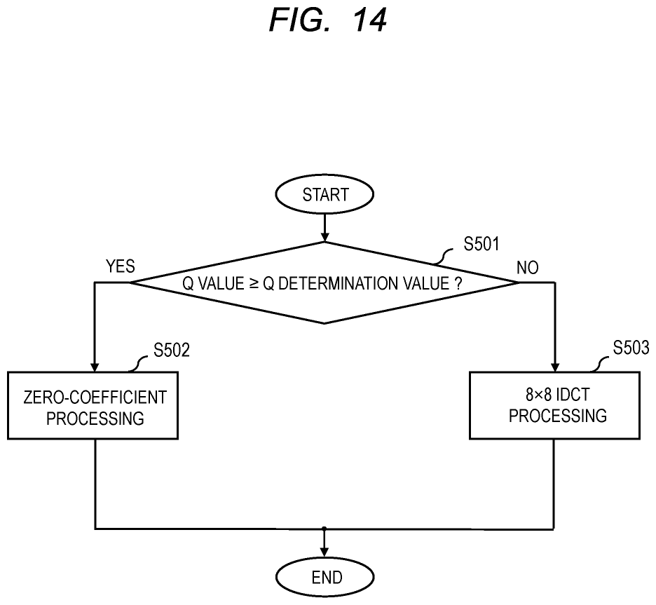

FIG. 14 is a flowchart showing an example of a processing flow of the Q value determination unit 401 according to the second embodiment. As shown in FIG. 14, in a step S501, the Q value determination unit 401 compares a Q value obtained from Q value information with a Q determination value stored in the Q determination value register 402, and determines whether or not the Q value is equal to or larger than the Q determination value. If it is determined that the Q value is equal to or larger than the Q determination value (YES in the step S501), the processing proceeds to a step S502. On the other hand, when it is determined that the Q value is not equal to or larger than the Q determination value (NO in the step S501), the processing proceeds to a step S503.

In the step S502, the Q value determination unit 401 determines the processing to be performed as the zero-coefficient determination processing. When the Q value is equal to or larger than the Q determination value, there is a strong tendency that the coefficients which are not 0 are concentrated inside the 4×4 region on the low frequency side in the 8×8 transform coefficient matrix. Therefore, it is presumed that the occurrence frequency of the zero-coefficient determination result indicating that the 4×4 IDCT processing is to be performed is high in the zero-coefficient determination unit 132a. Therefore, the Q value determination unit 401 determines that the zero-coefficient determination processing should be performed.

In the step S503, the Q value determination unit 401 determines the processing to be performed as the 8×8 IDCT processing. When the Q value is not equal to or larger than the Q determination value, there is a strong tendency that the coefficients which are not 0 are dispersed outside the 4×4 region on the low frequency side in the 8×8 transform coefficient matrix. Therefore, it is presumed that the occurrence frequency of the zero-coefficient determination result indicating that the 4×4 IDCT processing is to be performed is low in the zero-coefficient determination unit 132a. Therefore, the Q value determination unit 401 determines the processing to be performed as the 8×8 IDCT processing without performing the zero-coefficient determination processing by the zero-coefficient determination unit 132a.

In the first embodiment, the processing amount of the entire zero-coefficient determination processing can be reduced by performing the zero-coefficient determination processing based on the ZRL information. However, the zero-coefficient determination processing itself is not unnecessary. In particular, in a case where the occurrence frequency of the zero-coefficient determination result indicating that the 4×4 IDCT processing is to be performed is low in the zero-coefficient determination unit 132a although the EOB determination unit 131 determines that the zero-coefficient determination processing should be performed, the efficiency in performing the zero-coefficient determination processing is low.

However, according to the second embodiment, it is determined whether or not to perform the zero-coefficient determination processing by presuming the coefficient distribution of the transform coefficient matrix based on the result of comparing the Q value with the Q determination value. That is, the zero-coefficient determination processing is performed only when the Q value is equal to or larger than the Q determination value and it is presumed that the occurrence frequency of the zero-coefficient determination result indicating that the 4×4 IDCT processing is to be performed is high in the zero-coefficient determination unit 132a. On the other hand, when the Q value is smaller than the Q determination value and it is presumed that the occurrence frequency of the zero-coefficient determination result indicating that the 4×4 IDCT processing is to be performed is low in the zero-coefficient determination unit 132a, the 8×8 IDCT processing is determined without performing the zero-coefficient determination processing. This reduces the frequency with which the unnecessary zero-coefficient determination processing is performed. As a result, the processing amount of the zero-coefficient determination processing is reduced, and the decoding processing is further speeded up.

The decoding device 100a of the second embodiment has an advantage over the decoding device 100 of the first embodiment when image data having a low Q value and a high probability of being performed the 8×8 IDCT processing is decoded.

In the second embodiment, since the Q determination value can be arbitrarily set, the Q determination value can be adjusted to various image data. If a large value is set to the Q determination value, the processing amount of the zero-coefficient determination processing is reduced, and the 8×8 IDCT processing is performed more frequently. On the other hand, if a small value is set to the Q determination value, the same operation as the first embodiment is performed. The Q determination value may be tested using a plurality of Q determination values for a plurality of sample images, and an optimal Q determination value may be prepared in advance based on the test results.

### Third Embodiment

Next, a third embodiment will be described. In the third embodiment, components having the same functions as those of the first and second embodiments are denoted by the same reference numerals, and descriptions thereof are omitted.

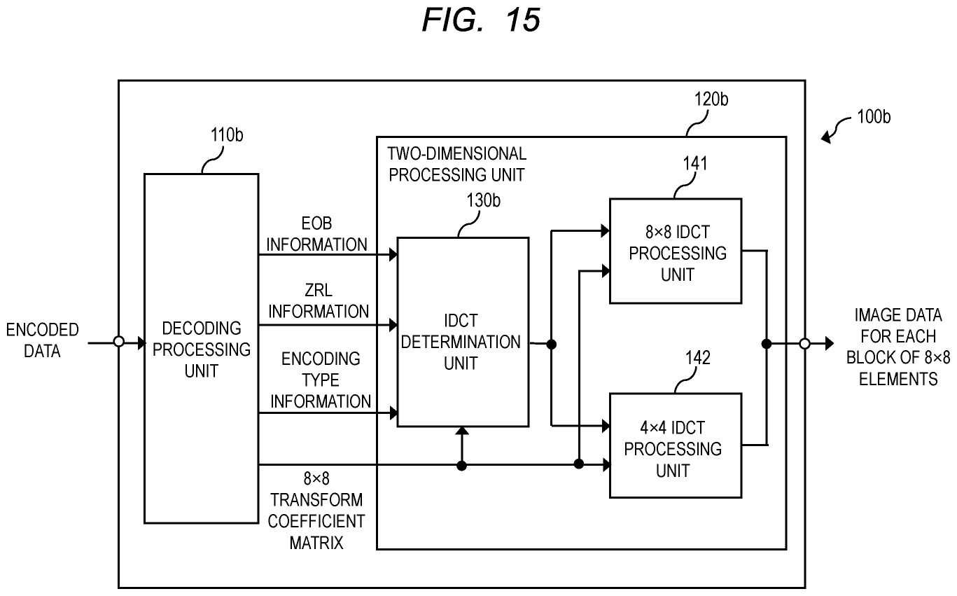

FIG. 15 is a block diagram showing an example of a configuration of a decoding device 100b according to the third embodiment. The decoding device 100b according to the third embodiment is another embodiment of the decoding device 100 according to the first embodiment. As shown in FIG. 15, the decoding device 100b includes a decoding processing unit 110b and a two-dimensional IDCT processing unit 120b.

The decoding processing unit 110b outputs encoding type information to the two-dimensional IDCT processing unit 120b in addition to an 8×8 transform coefficient matrix, EOB information, and ZRL information.

The two-dimensional IDCT processing unit 120b includes an IDCT determination unit 130b, the 8×8 IDCT processing unit 141, and the 4×4 IDCT processing unit 142. The IDCT determination unit 130b is connected to the decoding processing unit 110b, the 8×8 IDCT processing unit 141, and the 4×4 IDCT processing unit 142. The IDCT determination unit 130b receives the encoding type information in addition to the 8×8 transform coefficient matrix, the EOB information, and the ZRL information from the decoding processing unit 110b.

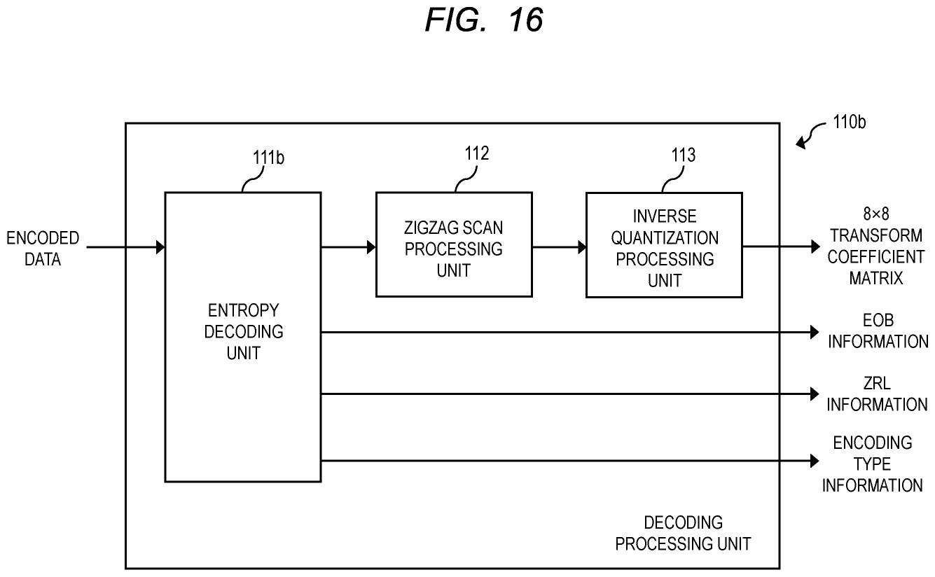

FIG. 16 is a block diagram showing an example of a configuration of the decoding processing unit 110b according to the third embodiments. As shown in FIG. 16, the entropy decoding unit 111 of FIG. 6 is changed to an entropy decoding unit 111b.

In the MPEG method, two encoding processing, i.e., intra-encoding and inter-encoding, are selectively performed. The intra-encoding is a method in which encoding is performed using only image data in the same frame. The inter-encoding is a method in which encoding is performed using image data of a plurality of frames. Encoded data includes encoding type information which is information indicating whether image data for each block of 8×8 pixels is encoded by using intra-encoding or inter-encoding.

When the intra-encoding is used, the coefficients which are not 0 and included in the transform coefficient matrix tend to concentrate on the low frequency side. On the other hand, when the inter-encoding is used, the coefficients which are not 0 and included in the transform coefficient matrix tend to be dispersed without concentrating on the low frequency side. That is, the distribution of the coefficient which is not 0 and included in the transform coefficient matrix largely depends on the encoding type. The reason why the tendency of the coefficients to be dispersed in the case of the inter-encoding is stronger than in the case of the intra-encoding is that the inter-encoding converts a difference image.

The entropy decoding unit 111b receives an entropy encoded sequence which is encoded data obtained by entropy encoding processing, and performs decoding processing. The entropy decoding unit 111b is connected to the zigzag scan processing unit 112, and outputs the decoded transform coefficient sequence to the zigzag scan processing unit 112. The entropy decoding unit 111b outputs EOB information, ZRL information, and encoding type information obtained by the decoding processing to the two-dimensional IDCT processing unit 120b.

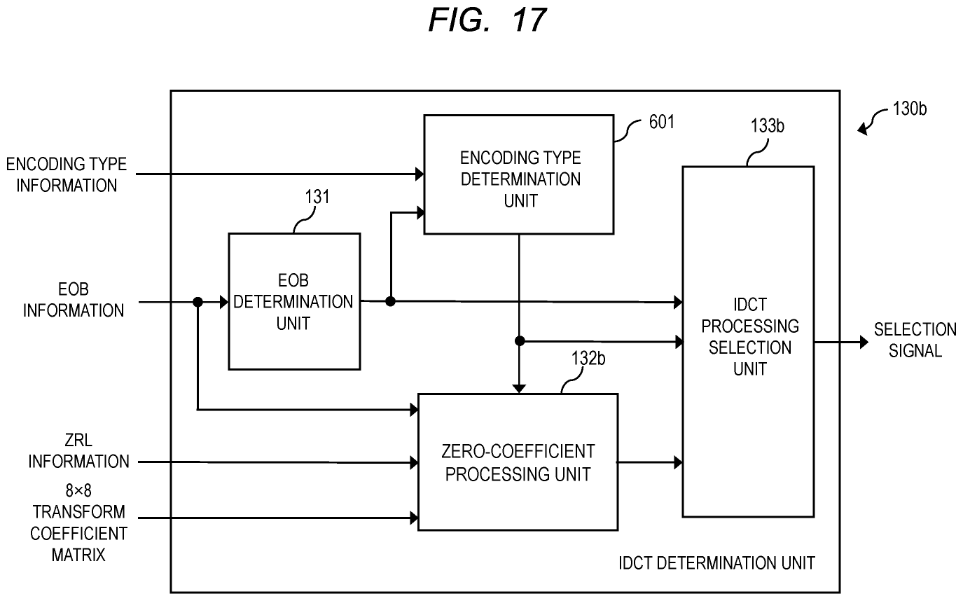

FIG. 17 is a block diagram showing an example of a configuration of the IDCT determination unit 130b according to the third embodiment. As shown in FIG. 17, the zero-coefficient determination unit 132 and the IDCT processing selection unit 133 of FIG. 7 are changed to the zero-coefficient determination unit 132b and the IDCT processing selection unit 133b, respectively. The IDCT determination unit 130b includes an encoding type determination unit 601 in addition to the configuration of the IDCT determination unit 130 shown in FIG. 7.

The encoding type determination unit 601 is connected to the decoding processing unit 110b, the EOB determination unit 131, the zero-coefficient determination unit 132b, and the IDCT processing selection unit 133b. The encoding type determination unit 601 receives the encoding type information output from the decoding processing unit 110b and the EOB determination result output from the EOB determination unit 131.

When receiving the EOB determination result indicating that the zero-coefficient determination processing is to be performed from the EOB determination unit 131, the encoding type determination unit 601 determines whether to perform either the 8×8 IDCT processing or the zero-coefficient determination processing based on the encoding type information. The encoding type determination unit 601 outputs the determination result to the zero-coefficient determination unit 132b and the IDCT processing selection unit 133b as an encoding type determination result.

The zero-coefficient determining unit 132b is connected to the decoding processing unit 110b, the encoding type determining unit 601, and the IDCT processing selection unit 133b. When receiving the encoding type determination result indicating that the zero-coefficient determination processing is to be performed from the encoding type determination unit 601, the zero-coefficient determination unit 132b determines whether to perform either the 8×8 IDCT processing and the 4×4 IDCT processing based on the 8×8 transform coefficient matrix, the EOB information, and the ZRL information received from the decoding processing unit 110b. The zero-coefficient determination unit 132b outputs the determination result to the IDCT processing selection unit 133b as the zero-coefficient determination result.

The IDCT processing selection unit 133b is connected to the EOB determination unit 131, the encoding type determination unit 601, the zero-coefficient determination unit 132b, the 8×8 IDCT processing unit 141, and the 4×4 IDCT processing unit 142. When receiving the EOB determination result indicating that the 8×8 IDCT processing is to be performed from the EOB determination unit 131, the encoding type determination result indicating that the 8×8 IDCT processing is to be performed from the encoding type determination unit 601, or the zero-coefficient determination result indicating that the 8×8 IDCT processing is to be performed from the zero-coefficient determination unit 132b, the IDCT processing selection unit 133b generates the selection signal indicating that the 8×8 IDCT processing is to be performed. On the other hand, when receiving the EOB determination result indicating that the 4×4 IDCT processing is to be performed from the EOB determination unit 131 or the zero-coefficient determination result indicating that the 4×4 IDCT processing is to be performed from the zero-coefficient determination unit 132b, the IDCT processing selection unit 133b generates the selection signal indicating that the 4×4 IDCT processing is to be performed. The generated selection signal is output to the 8×8 IDCT processing unit 141 and the 4×4 IDCT processing unit 142.

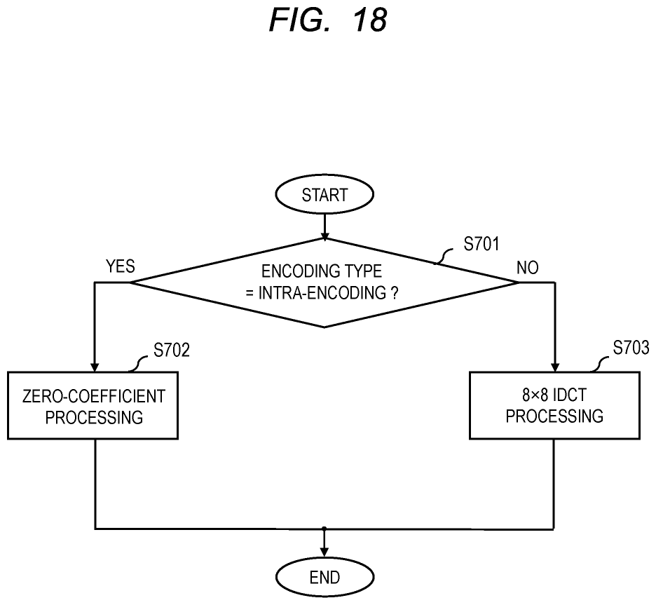

FIG. 18 is a flowchart showing an example of a processing flow of the encoding type determination unit 601 according to the third embodiment. As shown in FIG. 18, in a step S701, the encoding type determination unit 601 confirms encoding type information received from the decoding processing unit 110b, and determines whether or not the encoding type is the intra-encoding. If it is determined that the encoding type is the intra-encoding (YES in the step S701), the processing proceeds to a step S702. On the other hand, if it is determined that the encoding type is not the intra-encoding, that is, the inter-encoding (NO in the step S701), the processing proceeds to a step S703.

In the step S702, the encoding type determination unit 601 determines the processing to be performed as the zero-coefficient determination processing. When the encoding type is the intra-encoding, there is a strong tendency that the coefficients which are not 0 are concentrated inside the 4×4 region on the low frequency side in the 8×8 transform coefficient matrix. Therefore, it is presumed that the occurrence frequency of the zero-coefficient determination result indicating that the 4×4 IDCT processing is to be performed is high in the zero-coefficient determination unit 132b. As a result, the encoding type determination unit 601 determines that zero-coefficient determination processing should be performed.

In the step S703, the encoding type determination unit 601 determines the processing to be performed as the 8×8 IDCT processing. When the encoding type is not the intra-encoding, that is, is the inter-encoding, there is a strong tendency that the coefficients which are not 0 are dispersed outside the 4×4 region on the low frequency side in the 8×8 transform coefficient matrix. Therefore, it is presumed that the occurrence frequency of the zero-coefficient determination result indicating that the 4×4 IDCT processing is to be performed is low in the zero-coefficient determination unit 132b. Therefore, the coding-type determination unit 601 determines the processing to be executed as the 8×8 IDCT processing without performing the zero-coefficient determination processing by the zero-coefficient determination unit 132b.

As described above, according to the third embodiment, it is determined whether or not to perform the zero-coefficient determination processing by presuming the coefficient distribution of the transform coefficient matrix in accordance with the encoding type. That is, the zero-coefficient determination processing is performed only when the encoding type is the intra-encoding and it is presumed that the occurrence frequency of the zero-coefficient determination result indicating that the 4×4 IDCT processing is to be performed is high in the zero-coefficient determination unit 132b. On the other hand, when the encoding type is the inter-encoding and it is presumed that the occurrence frequency of the zero-coefficient determination result indicating that the 4×4 IDCT processing is to be performed is low in the zero-coefficient determination unit 132b, the 8×8 IDCT processing is determined without performing the zero-coefficient determination processing. This reduces the frequency with which the unnecessary zero-coefficient determination processing is performed. Therefore, the processing amount of the zero-coefficient determination processing is reduced, and the decoding processing is further speeded up.

The decoding device 100b of the third embodiment has an advantage over the decoding device 100 of the first embodiment when image data having a high rate of the inter-encoding and a high probability of being performed the 8×8 IDCT processing is decoded.

In addition, since it is determined whether to perform the zero-coefficient determination processing by using the information indicating whether the image data included in the encoded data has been encoded by the intra-encoding or the inter-encoding in the third embodiment, there is an advantage that the third embodiment can be easily implemented in a decoding device.

The decoding devices 100, 100a and 100b in the first to third embodiments may be configured by one or more semiconductor devices. The semiconductor device may be configured by one or more semiconductor chips. For example, the decoding processing unit 110 and the two-dimensional IDCT processing unit 120 may be one semiconductor device formed on one semiconductor chip, and the decoding processing unit 110 and the two-dimensional IDCT processing unit 120 may be one semiconductor device formed on different semiconductor chips.

Each block included in the decoding devices 100, 100a, and 100b can be configured only by hardware (H/W) or by cooperation of H/W and software (S/W). That is, FIGS. 5 to 7, 11 to 13, and 15 to 17 depict functional blocks realized only by H/W, only by S/W, or by the cooperation of H/W and S/W.

When each block included in the decoding devices 100, 100a, and 100b is configured only by H/W, each block of included in the decoding devices 100, 100a, and 100b is configured by circuits. On the other hand, when each block included in the decoding devices 100, 100a, and 100b is configured by the cooperation of H/W and S/W, for example, the IDCT determination units 130, 130a, and 130b are configured by processors, and the functions of the IDCT determination units 130, 130a, and 130b can be realized by the processors reading out and executing predetermined programs stored in a storage unit (not shown).

In the first to third embodiments, the IDCT determination units 130, 130a, and 130b have been described as being implemented in the decoding devices 100, 100a, and 100b, but they may be implemented in the encoding device. That is, even if they are implemented in the encoding device, it is possible to generate the selection signal indicating either the 8×8 IDCT processing or the 4×4 IDCT processing is to be performed based on the transform coefficient matrix, the EOB information, the ZRL information, the Q value information, and the encoding type information. In this instance, the decoding devices 100, 100a, and 100b receive the selection signal output from the encoding device, control the switching between the 8×8 IDCT processing unit 141 and the 4×4 IDCT processing unit 142 based on the received selection signal, and perform two types of the IDCT processing. For example, in a system having a plurality of decoding devices for one encoding device, the processing amount of the entire system can be reduced by implementing the IDCT determination units 130, 130a, and 130b in the encoding device. Although the invention made by the present inventor has been specifically described based on the embodiments, it is needless to say that the present invention is not limited to the above-described embodiments, and various changes may be made without departing from the scope thereof.

What is claimed is:

1. A decoding device which performs m×n element Inverse Discrete Cosine Transform (IDCT) processing or p×q element IDCT processing on a transform coefficient matrix with m×n elements on which Discrete Cosine Transform (DCT) processing has been performed for each block of m×n pixels, the m, n, p and q being natural numbers of 2 or more and having a relationship of m>p and n≥q, or m≥p and n>q, the decoding device comprising:
a decoding processing unit configured to decode an encoded transform coefficient sequence, to output the transform coefficient matrix with the m×n elements obtained by rearranging a decoded transform coefficient sequence in a form of a zigzag scan matrix, End-Of-Block (EOB) information indicating a location of a last coefficient which in not 0 in the transform coefficient matrix with the m×n elements, Zero-Run-Length (ZRL) information indicating the number of coefficients which is 0 between the last coefficient which is not 0, and a coefficient which is not 0 and which is located immediately before the last coefficient which is not 0 in the transform coefficient matrix with the m×n elements; and
a two-dimensional IDCT processing unit configured to perform the m×n element IDCT processing or the p×q element IDCT processing on the transform coefficient matrix with the m×n elements,
wherein all of the m×n elements of the transform coefficient matrix with the m×n elements are processed as effective elements in the m×n element IDCT processing,
wherein p×q elements located in a low frequency side region of the transform coefficient matrix with the m×n elements are processed as effective elements in the p×q element IDCT processing,
wherein the two-dimensional IDCT processing unit comprises:
an IDCT determination unit configured to determine the number of elements in a row direction and a column direction required to select the m×n element IDCT processing or the p×q element IDCT processing based on the transform coefficient matrix with the m×n elements, the EOB information and the ZRL information;
an m×n IDCT processing unit configured to perform the m×n element IDCT processing; and
a p×q IDCT processing unit configured to perform the p×q element IDCT processing,
wherein the m×n IDCT processing unit and the p×q IDCT processing unit are configured to selectively perform the m×n element IDCT processing or the p×q element IDCT processing on the transform coefficient matrix with the m×n elements based on a determination result by the IDCT determination unit, and to restore image data for each block of m×n pixels.

2. The decoding device according to claim 1, wherein the IDCT determination unit is configured to:
if a scan number indicated in the EOB information is a maximum scan number among scan numbers of coefficients included in the p×q elements, determine whether all of coefficients of scan numbers between a coefficient of the maximum scan number, and the coefficient of the scan number located immediately before the coefficient of the maximum scan number and included in the p×q elements are 0 based on the ZRL information, and
if it is determined that all of the coefficients of the scan numbers between the coefficient of the maximum scan number, and the coefficient of the scan number located immediately before the coefficient of the maximum scan number and included in the p×q elements are 0, determine that the p×q element IDCT processing is to be performed.

3. The decoding device according to claim 1, wherein the IDCT determination unit is configured to:
if a scan number indicated in the EOB information is a maximum scan number among scan numbers of coefficients included in the p×q elements, determine whether all of coefficients of scan numbers between a coefficient of the maximum scan number, and the coefficient of the scan number located immediately before the coefficient of the maximum scan number and included in the p×q elements are 0 based on the ZRL information, and
if it is determined that all of the coefficients of the scan numbers between the coefficient of the maximum scan number, and the coefficient of the scan number located immediately before the coefficient of the maximum scan number and included in the p×q elements are not 0, determine that the m×n element IDCT processing is to be performed.

4. The decoding device according to claim 1,
wherein the IDCT determination unit comprises:
an EOB determination unit configured to determine whether one of the m×n element IDCT processing, the p×q element IDCT processing and zero-coefficient determination processing is to be performed and to output an EOB determination result;
a zero-coefficient determination unit configured to determine one of the m×n element IDCT processing and the p×q element IDCT processing is to be performed based on the transform coefficient matrix with the m×n elements, the EOB information and the ZRL information and to output a zero-coefficient determination result, if the EOB determination result indicating that the zero-coefficient determination processing is to be performed is received; and
an IDCT processing selection unit configured to generate a selection signal indicating that the m×n element IDCT processing is to be performed if the EOB determination result indicating that the m×n element IDCT processing is to be executed or the zero-coefficient determination result indicating that the m×n element IDCT processing is to be performed is received, and to generate the selection signal indicating that the p×q element IDCT processing is to be performed if the EOB determination result indicating that the p×q element IDCT processing is to be executed or the zero-coefficient determination result indicating that the p×q element IDCT processing is to be performed is received,
wherein the m×n IDCT processing unit and the p×q IDCT processing unit are configured to selectively perform the m×n element IDCT processing or the p×q element IDCT processing on the transform coefficient matrix with the m×n elements based on the selection signal.

5. The decoding device according to claim 4, wherein the zero-coefficient determination unit is configured to:
if a scan number indicated in the EOB information is a maximum scan number among scan numbers of coefficients included in the p×q elements, determine whether all of coefficients of scan numbers between a coefficient of the maximum scan number, and the coefficient of the scan number located immediately before the coefficient of the maximum scan number and included in the p×q elements are 0 based on the ZRL information, and
if it is determined that all of the coefficients of the scan numbers between the coefficient of the maximum scan number, and the coefficient of the scan number located immediately before the coefficient of the maximum scan number and included in the p×q elements are 0, determine that the p×q element IDCT processing is to be performed.

6. The decoding device according to claim 4, wherein the zero-coefficient determination unit is configured to:
if a scan number indicated in the EOB information is a maximum scan number among scan numbers of coefficients included in the p×q elements, determine whether all of coefficients of scan numbers between a coefficient of the maximum scan number, and the coefficient of the scan number located immediately before the coefficient of the maximum scan number and included in the p×q elements are 0 based on the ZRL information, and
if it is determined that all of the coefficients of the scan numbers between the coefficient of the maximum scan number, and the coefficient of the scan number located immediately before the coefficient of the maximum scan number and included in the p×q elements are not 0, determine that the m×n element IDCT processing is to be performed.

7. The decoding device according to claim 4, wherein the EOB determination unit is configured to:
determine whether a scan number indicated in the EOB information is less than a minimum scan number among scan numbers of coefficients which are not included in the p×q elements;
determine that the p×q element IDCT processing is to be performed if the scan number indicated in the EOB information is less than the minimum scan number is determined;
determine whether the scan number indicated in the EOB information is more than a maximum scan number among scan numbers of coefficients which are included in the p×q elements;
determine that the m×n element IDCT processing is to be performed if the scan number indicated in the EOB information is more than the maximum scan number is determined;
determine whether the scan number indicated in the EOB information is equal to or more than the minimum scan number, and is equal to or less than the maximum scan number; and
determine that the zero-efficient determination processing is to be performed if the scan number indicated in the EOB information is equal to or more than the minimum scan number, and is equal to or less than the maximum scan number is determined.

8. The decoding device according to claim 1,
wherein the m and n are 8, respectively and
wherein the p and q are 4, respectively.

9. The decoding device according to claim 8, wherein the IDCT determination unit is configured to:
determine whether the ZRL information is 5 or more if a scan number indicated in the EOB information is 24; and
if the ZRL information is 5 or more is determined, determine that all coefficients of scan numbers 19 to 23 in the transform coefficient matrix with the 8×8 elements are 0, and that the 4×4 element IDCT processing is to be performed.

10. The decoding device according to claim 8, wherein the IDCT determination unit is configured to:
determine whether the ZRL information is 5 or more if a scan number indicated in the EOB information is 24; and
if the ZRL information is not 5 or more is determined, determine that any of the coefficients of scan numbers 19 to 23 in the transform coefficient matrix with the 8×8 elements include a coefficient which is not 0, and that the 8×8 element IDCT processing is to be performed.

11. The decoding device according to claim 8,
wherein the IDCT determination unit comprises:
an EOB determination unit configured to determine whether one of the 8×8 element IDCT processing, the 4×4 element IDCT processing and zero-coefficient determination processing is to be performed and to output an EOB determination result;
a zero-coefficient determination unit configured to determine one of the 8×8 element IDCT processing and the 4×4 element IDCT processing is to be performed based on the transform coefficient matrix with the 8×8 elements, the EOB information and the ZRL information and to output a zero-coefficient determination result, if the EOB determination result indicating that the zero-coefficient determination processing is to be performed is received; and
an IDCT processing selection unit configured to generate a selection signal indicating that the 8×8 element IDCT processing is to be performed if the EOB determination result indicating that the 8×8 element IDCT processing is to be executed or the zero-coefficient determination result indicating that the 8×8 element IDCT processing is to be performed is received, and to generate the selection signal indicating that the 4×4 element IDCT processing is to be performed if the EOB determination result indicating that the 4×4 element IDCT processing is to be executed or the zero-coefficient determination result indicating that the 4×4 element IDCT processing is to be performed is received,
wherein the m×n IDCT processing unit and the p×q IDCT processing unit are configured to selectively perform the 8×8 element IDCT processing or the 4×4 element IDCT processing on the transform coefficient matrix with the 8×8 elements based on the selection signal.

12. The decoding device according to claim 11, wherein the zero-coefficient determination unit is configured to:
determine whether the ZRL information is 5 or more if a scan number indicated in the EOB information is 24; and
if the ZRL information is 5 or more is determined, determine that all coefficients of scan numbers 19 to 23 in the transform coefficient matrix with the 8×8 elements are 0, and that the 4×4 element IDCT processing is to be performed.

13. The decoding device according to claim 11, wherein the zero-coefficient determination unit is configured to:
determine whether the ZRL information is 5 or more if a scan number indicated in the EOB information is 24; and
if the ZRL information is not 5 or more is determined, determine that any of the coefficients of scan numbers 19 to 23 in the transform coefficient matrix with the 8×8 elements include a coefficient which is not 0, and that the 8×8 element IDCT processing is to be performed.

14. The decoding device according to claim 11, wherein the EOB determination unit is configured to:
determine whether a scan number indicated in the EOB information is less than 10;
determine that the 4×4 element IDCT processing is to be performed if the scan number indicated in the EOB information is less than 10 is determined;
determine whether the scan number indicated in the EOB information is more than 24;
determine that the 8×8 element IDCT processing is to be performed if the scan number indicated in the EOB information is more than 24 is determined;
determine whether the scan number indicated in the EOB information is 10 or more, and is 24 or less; and
determine that the zero-efficient determination processing is to be performed if the scan number indicated in the EOB information is 10 or more, and is 24 or less is determined.

15. The decoding device according to claim 1,
wherein the decoding processing unit comprising:
an entropy decoding unit configured to decode encoded data including the encoded transform coefficient sequence, and to output the decoded transform coefficient sequence, the EOB information and the ZRL information obtained by decoding the encoded data;
a zigzag scan processing unit configured to generate the transform coefficient matrix with the m×n elements obtained by rearranging the decoded transform coefficient sequence in the form of the zigzag scan matrix; and
an inverse quantization processing unit configured to perform inverse quantization processing by multiplying each element of the transform coefficient matrix with the m×n elements by each element of a quantization matrix with m×n elements,
wherein the transform coefficient matrix with the m×n elements inversely quantized by the inverse quantization processing unit is output to the two-dimensional IDCT processing unit.

16. The decoding device according to claim 15,
wherein the inverse quantization processing unit is configured to output a quantization coefficient value (Q value) used for determining a value of each element of the quantization matrix with the m×n elements to the IDCT determination unit as Q value information,
wherein the IDCT determination unit comprises:
an EOB determination unit configured to determine whether one of the m×n element IDCT processing, the p×q element IDCT processing and zero-coefficient determination processing is to be performed and to output an EOB determination result;
a Q value determination unit comprising a Q determination value register storing a Q determination value, and configured to determine whether one of the m×n element IDCT processing and the zero-coefficient determination processing is to be performed based on the Q value obtained by the Q value information and the Q determination value stored in the Q determination value register to output a Q value determination result if the EOB determination result indicating that the zero-coefficient determination processing is to be performed is received;
a zero-coefficient determination unit configured to determine one of the m×n element IDCT processing and the p×q element IDCT processing is to be performed based on the transform coefficient matrix with the m×n elements, the EOB information and the ZRL information and to output a zero-coefficient determination result, if the Q value determination result indicating that the zero-coefficient determination processing is to be performed is received; and
an IDCT processing selection unit configured to generate a selection signal indicating that the m×n element IDCT processing is to be performed if the EOB determination result indicating that the m×n element IDCT processing is to be executed, the Q value determination result indicating that the m×n element IDCT processing is to be performed or the zero-coefficient determination result indicating that the m×n element IDCT processing is to be performed is received, and to generate the selection signal indicating that the p×q element IDCT processing is to be performed if the EOB determination result indicating that the p×q element IDCT processing is to be executed or the zero-coefficient determination result indicating that the p×q element IDCT processing is to be performed is received,
wherein the m×n IDCT processing unit and the p×q IDCT processing unit are configured to selectively perform the m×n element IDCT processing or the p×q element IDCT processing on the transform coefficient matrix with the m×n elements based on the selection signal.

17. The decoding device according to claim 15,
wherein the entropy decoding unit is configured to output, to the DCT determination unit, encoding type information indicating whether the encoded data is encoded by intra-coding or inter-coding,
wherein the IDCT determination unit comprises:
an EOB determination unit configured to determine whether one of the m×n element IDCT processing, the p×q element IDCT processing and zero-coefficient determination processing is to be performed and to output an EOB determination result;
an encoding type determination unit configured to determine whether one of the m×n element IDCT processing and the zero-coefficient determination processing is to be performed based on the encoding type information to output an encoding type determination result if the EOB determination result indicating that the zero-coefficient determination processing is to be performed is received;
a zero-coefficient determination unit configured to determine one of the m×n element IDCT processing and the p×q element IDCT processing is to be performed based on the transform coefficient matrix with the m×n elements, the EOB information and the ZRL information and to output a zero-coefficient determination result, if the encoding type determination result indicating that the zero-coefficient determination processing is to be performed is received; and
an IDCT processing selection unit configured to generate a selection signal indicating that the m×n element IDCT processing is to be performed if the EOB determination result indicating that the m×n element IDCT processing is to be executed, the encoding type determination result indicating that the m×n element IDCT processing is to be performed or the zero-coefficient determination result indicating that the m×n element IDCT processing is to be performed is received, and to generate the selection signal indicating that the p×q element IDCT processing is to be performed if the EOB determination result indicating that the p×q element IDCT processing is to be executed or the zero-coefficient determination result indicating that the p×q element IDCT processing is to be performed is received,
wherein the m×n IDCT processing unit and the p×q IDCT processing unit are configured to selectively perform the m×n element IDCT processing or the p×q element IDCT processing on the transform coefficient matrix with the m×n elements based on the selection signal.

18. A control method of a decoding device which includes a decoding processing unit and a two-dimensional Inverse Discrete Cosine Transform (IDCT) processing unit, and performs m×n element IDCT processing or p×q element IDCT processing on a transform coefficient matrix with m×n elements on which Discrete Cosine Transform (DCT) processing has been performed for each block of m×n pixels, the m, n, p and q being natural numbers of 2 or more and having a relationship of m>p and n≥q, or m≥p and n>q, the control method of the decoding device comprising:
decoding an encoded data including an encoded transform coefficient sequence by the decoding processing unit; and
performing configured to perform the m×n element IDCT processing or the p×q element IDCT processing on the transform coefficient matrix with the m×n elements by the two-dimensional IDCT processing unit,
wherein all of the m×n elements of the transform coefficient matrix with the m×n elements are processed as effective elements in the m×n element IDCT processing,
wherein p×q elements located in a low frequency side region of the transform coefficient matrix with the m×n elements are processed as effective elements in the p×q element IDCT processing,
wherein the decoding comprises:
outputting the transform coefficient matrix with the m×n elements obtained by rearranging a decoded transform coefficient sequence in a form of a zigzag scan matrix;
outputting End-Of-Block (EOB) information indicating a location of a last coefficient which is not 0 in the transform coefficient matrix with the m×n elements; and
outputting Zero-Run-Length (ZRL) information indicating the number of coefficients which is 0 between the last coefficient which is not 0, and a coefficient which is not 0 and which is located immediately before the last coefficient which is not 0 in the transform coefficient matrix with the m×n elements,
wherein the performing comprises:
determining the number of elements in a row direction and a column direction required to select the m×n element IDCT processing or the p×q element IDCT processing based on the transform coefficient matrix with the m×n elements, the EOB information and the ZRL information; and
selectively performing the m×n element IDCT processing or the p×q element IDCT processing on the transform coefficient matrix with the m×n elements based on a determination result by the determining to restore image data for each block of m×n pixels.

19. The control method of the decoding device according to claim 18, wherein the determining comprises:
confirming whether a scan number indicated in the EOB information is a maximum scan number among scan numbers of coefficients included in the p×q elements;
if it is confirmed that the scan number indicated in the EOB information is the maximum scan number, determining whether all of coefficients of scan numbers between a coefficient of the maximum scan number, and the coefficient of the scan number located immediately before the coefficient of the maximum scan number and included in the p×q elements are 0 based on the ZRL information, and
if it is determined that all of the coefficients of the scan numbers between the coefficient of the maximum scan number, and the coefficient of the scan number located immediately before the coefficient of the maximum scan number and included in the p×q elements are 0, determining that the p×q element IDCT processing is to be performed.

20. The control method of the decoding device according to claim 18, wherein the determining comprises:
confirming whether a scan number indicated in the EOB information is a maximum scan number among scan numbers of coefficients included in the p×q elements;
if it is confirmed that the scan number indicated in the EOB information is the maximum scan number, determining whether all of coefficients of scan numbers between a coefficient of the maximum scan number, and the coefficient of the scan number located immediately before the coefficient of the maximum scan number and included in the p×q elements are 0 based on the ZRL information, and
if it is determined that all of the coefficients of the scan numbers between the coefficient of the maximum scan number, and the coefficient of the scan number located immediately before the coefficient of the maximum scan number and included in the p×q elements are not 0, determining that the m×n element IDCT processing is to be performed.
